(19) United States
(12) Patent Application Publication
(10) Pub. No.: US 2025/0363338 A1
(43) Pub. Date: Nov. 27, 2025

(54) METHOD AND SYSTEM FOR PROCESSING EVENT-BASED DATA IN EVENT-BASED SPATIOTEMPORAL NEURAL NETWORKS

(71) Applicant: BrainChip, Inc., Laguna Hills, CA (US)

(72) Inventor: Olivier Jean-Marie Dominique COENEN, Laguna Hills, CA (US)

(21) Appl. No.: 18/875,148

(22) PCT Filed: Jun. 22, 2023
(86) PCT No.: PCT/US2023/025998

§ 371 Date: Dec. 15, 2024

Related U.S. Application Data
(60) Provisional application No. 63/354,525, filed on Jun. 22, 2022.

(51) Int. Cl. G06N 3/048

(52) U.S. Cl. CPC G06N 3/048

(57) ABSTRACT

Disclosed is a method for processing event-based input data using a neural network. The neural network comprises a plurality of neurons and one or more connections associated with each of the plurality of neurons. Further, each of the plurality of neurons is configured to receive a corresponding portion of the event-based data. The method comprises receiving, at a neuron of the plurality of neurons, a plurality of events associated with the event-based data over the one or more connections associated with the neuron. Each of the one or more connections is associated with a kernel. The method further comprises determining a potential of the neuron over the period of time based on processing of the kernels. In order to determine the potential, the method further comprises offsetting the kernels in one of a spatial dimension, a temporal dimension, or a spatiotemporal dimension, and processing the offset kernels in order to determine the potential. The method further comprises generating, at the neuron, output based on the determined potential.

### TECHNICAL FIELD

The present disclosure generally relates to the field of neural networks (NNs). In particular, the present disclosure relates to neural networks (NNs) that process event-based data, i.e., spatial, temporal, and/or spatiotemporal data, using event-based spatiotemporal neurons.

### BACKGROUND

Neural networks (NNs) are the basis of artificial intelligence (AI) technology. In general, Artificial Neural Network (ANN), Convolutional Neural Network (CNN), and Recurrent Neural Network (RNN) are some of the common types of NNs.

In general, ANNs were initially developed to replicate the behavior of biological neurons which communicate with each other via electrical signals known as “spikes”. The information conveyed by the neurons was initially believed to be mainly encoded in the rate at which the neurons emit the respective signals, i.e., “spikes”. Initially, nonlinearities in ANNs, such as sigmoid functions, were inspired by the saturating behavior of neurons. Neurons' firing activity reaches saturation as the neurons approach their maximum firing rate, and nonlinear functions, such as, sigmoid functions were used to replicate this behavior in ANNs. These nonlinear functions became activation functions and allowed ANNs to model complex nonlinear relationships between neuron inputs and outputs.

Further, the traditional ANNs require a large number of training data and computational resources to train the network effectively. Currently, most of the accessible data is available in spatiotemporal formats. To use the spatiotemporal forms of data effectively in machine learning applications, it is essential to design a lightweight network that can efficiently learn spatial and temporal features and correlations from data. At present, the convolutional neural network (CNN) is considered the prevailing standard for spatial networks, while the recurrent neural network (RNN) equipped with nonlinear gating mechanisms, such as long short-term memory (LSTM) and gated recurrent unit (GRU), is being preferred for temporal networks.

The CNNs are capable of learning crucial spatial correlations or features in spatial data, such as images or video frames, and gradually abstracting the learned spatial correlations or features into more complex features as the spatial data is processed layer by layer. These CNNs have become the predominant choice for image classification and related tasks over the past decade. This is primarily due to the efficiency in extracting spatial correlations from static input images and mapping them into their appropriate classifications with the fundamental engines of deep learning like gradient descent and backpropagation paring up together. This results in state-of-the-art accuracy for the CNNs. However, many modern Machine Learning (ML) workflows increasingly utilize data that come in spatiotemporal forms, such as natural language processing (NLP) and object detection from video streams. The CNN models lack the power to effectively use temporal data present in these application inputs. Importantly, CNNs fail to provide flexibility to encode and process temporal data efficiently. Thus, there is a need to provide flexibility to artificial neurons to encode and process temporal data efficiently.

Recently different methods to incorporate temporal or sequential data, including temporal convolution and internal state approaches have been explored. When temporal processing is a requirement, for example in NLP or sequence prediction problems, the RNNs such as long short-term memory (LSTM) and gated recurrent memory (GRU) models are utilized. Further, for applications that need both spatial and temporal processing, according to one conventional method 3D convolutions that combine 2D spatial convolution with a 1D temporal convolution have been used. Further, according to another conventional method, a 2D spatial convolution combined with state-based RNNs such as LSTMs or GRUs to process temporal information components using models such as ConvLSTM have been used. However, each of these conventional approaches comes with significant drawbacks. For example, combining the 2D spatial convolutions with 1D temporal convolutions is computationally expensive and is thus not appropriate for efficient low-power inference.

One of the main challenges with the RNNs is the involvement of excessive nonlinear operations at each time step, that leads to two significant drawbacks. Firstly, these nonlinearities force the network to be sequential in time i.e., making the RNNs difficult for efficiently leveraging parallel processing during training. Secondly, since the applied nonlinearities are ad-hoc in nature and lack a theoretical guarantee of stability, it is challenging to train the RNNs or perform inference over long sequences of time series data. These limitations also apply to models, for example, ConvLSTM models as discussed in the above paragraphs, that combine 2D spatial convolution with RNNs to process the sequential and temporal data.

In addition, for each of the above discussed NN models including ANN, CNN, and RNN, the computation process is very often performed in the cloud. However, in order to have a better user experience, privacy, and for various commercial reasons, implementation of the computation process has started moving from the cloud to edge devices. Various applications like video surveillance, self-driving video, medical vital signs, speech/audio related data are implemented in the edge devices.

Further, with the increasing complexity of the NN models, there is a corresponding increase in the computational requirements required to execute highly complex NN Models. Thus, a huge computational processing and a large memory are required for executing highly complex NN Models like CNNs and RNNs in the edge devices. This necessitates a large memory buffer (time window) of past inputs to perform temporal convolutions at every time step. However, maintaining such a large memory buffer can be very expensive and power-consuming.

Moreover, most conventional neural networks process data based on static mapping, i.e., the networks take a static input and map into another static output. However, real worlds, such as biological neurons, are not expressed as mapping, but by dynamical systems. In the domain of event-based data processing, there is a need for a power efficient implementation to process event-based data, such as, data generated by event-based sensors. With currently known networks, hardware realization of event-based implementation is difficult both with respect to silicon aspect and software aspect.

Currently, the known neural networks do not efficiently process event-based data, in fact, neural networks that effectively take full advantage of Lebesgue sampling do not exist yet. Lebesgue sampling means that a function y=ƒ(x) is discretized along the y-axis, not along the x-axis like it is typically done with Riemann sampling, typically periodic at equidistant intervals. Networks, such as LSTM, are hard to train, and further, take time to provide outputs. Further, networks having transformer design implementations are bulky, and hence, are not suitable for edge devices. The known neural networks do not achieve good accuracy when processing event-based data, rather, high number of computations are required with known networks.

Spiking neural networks (SNNs) aim to mimic the behavior of biological neurons and their communication through the generation and propagation of discrete electrical pulses, i.e., spikes. In the biological nervous system, neurons communicate with each other through electrical impulses or spikes. These spikes represent the fundamental units of information processing and transmission. SNNs model this behavior by using spikes as discrete events to convey information between artificial neurons. Information theory analysis of biological neurons has demonstrated that temporal spike coding plays a crucial role in information processing. Specifically, it has been revealed that the timing of spikes carries a lot more encoded information, surpassing the information carried by firing rates alone. In contrast, artificial neural networks primarily rely on firing rates as a means of encoding information, leading to a significant disparity in the power and efficiency compared to biological networks. Thus, artificial neural networks achieve less information processing capabilities and efficiency compared to biological networks that exploit the precise timing of spikes for encoding and communication.

The conventional techniques do not efficiently implement ‘spike’ based processing, particularly for spatiotemporal data. The inefficient processing of spatiotemporal data during the inference stage necessitates the design of systems that exhibit a selection of key attributes inspired by the intricate workings of the biological brain. By incorporating selected elements, effective implementation on hardware with limited computational resources, such as edge devices, can be achieved. Design considerations are required that capture the key principles of the biological brain in a simplified manner and enable efficient processing of spatiotemporal data within resource-constrained environments.

Accordingly, what is required is an architecture that is hardware optimized and memory efficient, and in addition, is fast and efficient for inference when processing event-based data. A light and power efficient system is desired that takes into consideration generation of ‘spikes’ or ‘events’, i.e., increased/decreased presence or absence of features based on timing and positional information for spatiotemporal data processing. In other words, there is a need for a light network with less parameters that processes event-based data with reduced latency and less computations, and further, that can be implemented in hardware with low computational resources, such as, edge devices. This facilitates meeting hardware and accuracy requirements as well as facilitate the transition of the computation process from cloud to edge devices.

### SUMMARY

This summary is provided to introduce a selection of concepts in a simplified form that is further described below in the Detailed Description section. This summary is not intended to identify or exclude key features or essential features of the claimed subject matter, nor is it intended to be used as an aid in determining the scope of the claimed subject matter.

According to an embodiment of the present disclosure, disclosed herein is a method for processing event-based data using a neural network. The neural network comprises a plurality of neurons and one or more connections associated with each of the plurality of neurons. Further, each of the plurality of neurons is configured to receive a corresponding portion of the event-based data. The method comprises receiving, at a neuron of the plurality of neurons, a plurality of events associated with the event-based data over the one or more connections associated with the neuron. Each of the one or more connections is associated with a first kernel and a second kernel, and each of the plurality of events belongs to one of a first category or a second category. The method further comprises determining, at the neuron, a potential by processing the plurality of events received over the one or more connections. To process the plurality of events, the method comprises selecting the first kernel for determining the potential when the received plurality of events belong to the first category and selecting the second kernel for determining the potential when the received plurality of events belong to the second category. The method further comprises generating, at the neuron, output based on the determined potential.

In some embodiments, the method comprises receiving an event of the plurality of events and determining the corresponding connection of the one or more connection over which the event is received. Further, the method comprises selecting one of the first kernel or the second kernel associated with the corresponding connection, based on whether the received event belongs to the first category or the second category. Further, the method comprises offsetting the selected kernel in one of a spatial dimension, a temporal dimension, or a spatiotemporal dimension, and determining the potential for the neuron based on processing of the offset kernel.

In some embodiments, generating the potential comprises summing the offset kernel with an earlier potential, thereby determining the potential at the neuron.

In some embodiments, to determine the potential, the method further comprises receiving an initial event at an initial time instance. The method further comprises receiving one or more subsequent events at subsequent time instances. The method further comprises determining the corresponding connections of the one or more connections over which the initial event and the one or more subsequent events are received. The method further comprises selecting, for each of the received initial event and the one or more subsequent events, one of the first kernel or the second kernel associated with the corresponding connections, based on whether the received initial event and the one or more subsequent events belong to the first category or the second category. The method further comprises offsetting one or more of the selected kernels in one of the temporal dimension or the spatiotemporal dimension based on the initial time instance and the subsequent time instances. The method further comprises determining the potential for the neuron based on processing of the offset kernels.

In some embodiments, to offset the kernels in one of the temporal dimension or the spatiotemporal dimension, the method further comprises determining time intervals between the initial time instance when a last event is received at the neuron and preceding time instances when one or more preceding events are received at the neuron, the time intervals defining a difference in time of arrival of the events at the neuron. The method further comprises offsetting the selected kernels corresponding to the one or more subsequent events based on the determined time intervals. The method further comprises summing the offset kernels in order to determine the potential at the neuron.

In some embodiments, each of the first kernel and the second kernel is represented as a sum of orthogonal polynomials, weighted by respective coefficients, wherein the respective coefficients are determined during training.

According to another embodiment of the present disclosure, disclosed herein is a method for processing event-based input data using a neural network. The neural network comprises a plurality of neurons and one or more connections associated with each of the plurality of neurons. Further, each of the plurality of neurons is configured to receive a corresponding portion of the event-based data. The method comprises receiving, at a neuron of the plurality of neurons, a plurality of events associated with the event-based data over the one or more connections associated with the neuron. Each of the one or more connections is associated with one or more kernels. The method further comprises determining a potential of the neuron over the period of time based on processing of the kernels. In order to determine the potential, the method further comprises offsetting the kernels in one of a spatial dimension, a temporal dimension, or a spatiotemporal dimension, and processing the offset kernels in order to determine the potential. The method further comprises generating, at the neuron, output based on the determined potential.

In some embodiments, offsetting the kernels in the temporal dimension comprises determining an offset value based on a time instance when the event is received at the neuron, and offsetting a corresponding kernel of the kernels in the temporal dimension based on the offset value. In some embodiments, offsetting the kernels in the spatial dimension comprises determining an offset value based on a position of an earlier neuron sending the event that is received at the neuron, and offsetting a corresponding kernel of the kernels in the spatial dimension based on the offset value. In some embodiments, offsetting the kernels in the spatiotemporal dimension comprises determining an offset value based on a time instance when the event is received at the neuron and a position of an earlier neuron sending the event that is received at the neuron, and offsetting a corresponding kernel of the kernels in the spatial dimension based on the offset value.

In some embodiments, the method comprises receiving, at the neuron, an initial event at an initial time instance. Further, the method comprises receiving, at the neuron, one or more subsequent events at subsequent time instances. Further, the method comprises offsetting the kernels corresponding to the one or more subsequent events received at the subsequent time instances with respect to kernels corresponding to the initial event received at the initial time instance. Further, the method comprises summing the kernels corresponding to the one or more subsequent events received at the subsequent time instances, and the kernels corresponding to the initial event received at the initial time instance, thereby determining the potential at the neuron over the period of time.

In some embodiments, each of the received events relates to increased presence or absence of one or more features of the event-based data when the corresponding events are associated with the first category or decreased presence or absence of one or more features of the event-based data when the corresponding events are associated with the second category.

According to an embodiment of the present disclosure, disclosed herein is a system to process event-based data using a neural network. The neural network comprises a plurality of neurons and one or more connections associated with each of the plurality of neurons. Each of the plurality of neurons associated with a corresponding portion of the event-based data received at the plurality of neurons. The system comprises a memory and a processor communicatively coupled to the memory. The processor is configured to receive, at a neuron of the plurality of neurons, a plurality of events associated with the event-based data over the one or more connections associated with the neuron. Each of the one or more connections is associated with a first kernel and a second kernel, and each of the plurality of events belongs to one of a first category or a second category. The processor is further configured to determine, at the neuron, a potential by processing the plurality of events received over the one or more connections. To process the plurality of events, the processor is configured to select the first kernel for determining the potential when the received plurality of events belong to the first category and select the second kernel for determining the potential when the received plurality of events belong to the second category. The processor is further configured to generating, at the neuron, output based on the determined potential.

According to an embodiment of the present disclosure, disclosed herein is a system to process event-based data using a neural network. The neural network comprises a plurality of neurons and one or more connections associated with each of the plurality of neurons. Each of the plurality of neurons associated with a corresponding portion of the event-based data received at the plurality of neurons. The system comprises a memory and a processor communicatively coupled to the memory. The processor is configured to receive, at a neuron of the plurality of neurons, a plurality of events associated with the event-based data over the one or more connections associated with the neuron. Each of the one or more connections is associated with a kernel. The processor is further configured to determine a potential of the neuron over the period of time based on processing of the kernels. In order to determine the potential, the processor is configured to offset the kernels in one of a spatial dimension, a temporal dimension, or a spatiotemporal dimension, and process the offset kernels in order to determine the potential. The processor is further configured to generate, at the neuron, output based on the determined potential.

### BRIEF DESCRIPTION OF DRAWINGS

Non-limiting and non-exhaustive embodiments of the invention are described with reference to the following figures, wherein reference numerals refer to like parts throughout the various views unless otherwise specified.

FIG. 1A-1C illustrate example system diagrams of an apparatus configured to implement a neural network, in accordance with various embodiments of the disclosure.

FIG. 2 illustrates another example system diagram of an apparatus configured to implement the neural network, in accordance with an embodiment of the disclosure.

FIGS. 3A-3B illustrate processing steps of a neuron receiving events associated with event-based data, in accordance with an embodiment of the disclosure.

FIGS. 4A-4B illustrate processing steps of a neuron receiving events associated with event-based data, in accordance with another embodiment of the disclosure.

FIGS. 5A-5B illustrate processing steps of a neuron receiving events associated with event-based data, in accordance with another embodiment of the disclosure.

FIGS. 6A-6B illustrate processing steps of multiple neurons receiving events associated with event-based data, in accordance with another embodiment of the disclosure.

FIGS. 7A-7B illustrate example representations of memory buffers storing events associated with neurons within the neural network, in accordance with an embodiment of the disclosure.

FIG. 8 illustrates schematically a neural network comprising a plurality of layers and a plurality of neurons that receive events associated with event-based data, in accordance with embodiment of the present disclosure.

FIG. 9A-9E illustrate example representations of kernels associated with the responses to input events of neurons within the neural network, according to an embodiment of the present disclosure.

FIG. 10A-10B illustrate various examples of kernel representations based on an expansion over basis functions, according to an embodiment of the present disclosure.

FIG. 10C illustrates a computation of a convolution operation when a kernel is represented as an expansion over basis functions, according to an embodiment of the present disclosure.

FIG. 11 illustrates an example representation of clocks associated with layers or neurons within the neural network running at different rates, according to an embodiment of the present disclosure.

FIG. 12A-12B illustrate a close-up view of block A in FIG. 8 in order to depict neurons and the associated connections and the flow of events in the network, in accordance with an embodiment of the present disclosure.

FIGS. 13A-13B illustrate schematic representations of offsetting, or centering, of kernels along the temporal dimension associated with each input event to a neuron for determining the potential of the neuron, in accordance with an embodiment of the disclosure.

FIG. 14 illustrates a schematic representation of offsetting, or centering, of kernels in both the temporal and spatial dimension associated with each input event to a neuron for determining the potential of the neuron, in accordance with another embodiment of the disclosure.

FIG. 15 is a flow chart of a method to process event-based data within the neural network, in accordance with an embodiment of the disclosure.

FIG. 16 is a flow chart of a method to process event-based data within the neural network, in accordance with another embodiment of the disclosure.

FIG. 17 is a flow chart of a method to process event-based data within the neural network, in accordance with yet another embodiment of the disclosure.

The features and advantages of the present disclosure will become more apparent from the detailed description set forth below when taken in conjunction with the drawings, in which similar reference numbers identify corresponding elements throughout. In the drawings, similar reference numbers generally indicate identical, functionally similar, and/or structurally similar elements. The drawing in which an element first appears is indicated by the leftmost digit(s) in the corresponding reference number.

### DETAILED DESCRIPTION

Various embodiments are described more fully below with reference to the accompanying drawings, which form a part hereof, and which show specific embodiments. However, the concepts of the present disclosure may be implemented in many different forms and should not be construed as limited to the embodiments set forth herein; rather, these embodiments are provided as part of a thorough and complete disclosure, to fully convey the scope of the concepts, techniques, and implementations of the present disclosure to those skilled in the art. Embodiments may be practiced as methods, systems, or devices. Accordingly, embodiments may take the form of a hardware implementation, an entire software implementation, or an implementation combining software and hardware aspects. The following detailed description is, therefore, not to be taken in a limiting sense.

Reference in the specification to “one embodiment”, “an embodiment”, “another embodiment”, or “some embodiment” means that a particular feature, structure, or characteristic described in connection with the embodiments is included in at least one example implementation or technique in accordance with the present disclosure. The appearances of the phrase “in an embodiment” in various places in the specification are not necessarily all referring to the same embodiment.

Some portions of the description that follow are presented in terms of symbolic representations of operations on non-transient signals stored within a computer memory. These descriptions and representations are used by those skilled in the data processing arts to most effectively convey the substance of their work to others skilled in the art.

In addition, the language used in the specification has been principally selected for readability and instructional purposes and may not have been selected to delineate or circumscribe the disclosed subject matter. Accordingly, the present disclosure is intended to be illustrative, and not limiting, of the scope of the concepts discussed herein.

Embodiments of the present disclosure may be implemented in hardware, firmware, software, or any combination thereof. Embodiments of the present disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others. Further, firmware, software, routines, and instructions may be described herein as performing certain actions. However, it should be appreciated that such descriptions are merely for convenience and that such actions result from computing devices, processors, controllers, or other devices executing the firmware, software, routines, instructions, etc.

Before describing such embodiments in more detail, however, it is instructive to present an example environment in which embodiments of the present disclosure may be implemented.

The present disclosure discloses neural networks (NNs), particularly related to neural networks (NNs) that are configured to process event-based data generated by event-based sensors. The event-based data may include spatial, temporal, and/or spatiotemporal data. The NNs may be configured to capture the event-based data, for instance, spatiotemporal information encoded by event-based sensors, and process the data for use in various application, such as, applications related to sensory processing and control through adaptive learning. Event-based sensors may include sensors that encode time varying signals using Lebesgue sampling, such as, but not limited to, vision, auditory, tactile, taste, inertial motion, and the like.

It is appreciated that the term “events” may refer to either a presence of one or more features of the event-based data or an absence of one or more features of the event-based data. In some embodiments, the term “events” may be associated with “spikes” in neural networks which are generated based on whether there is a presence of one or more features or an absence of one or more features of the event-based data. It is to be noted herein that the terms “events” and “spikes” may be interchangeably mentioned in the disclosure. It is appreciated that one or more embodiments may be explained with reference to “first kernel” and “second kernel” in which “first kernel” may refer to a “positive kernel” and “second kernel” may refer to a “negative kernel.” It is to be noted herein that the terms “first kernel” and “positive kernel” and the terms “second kernel” and “negative kernel” may be interchangeably mentioned in the disclosure. It is appreciated that one or more embodiments may be explained with reference to “events of first category” and “events of second category” in which “events of first category” may refer to a “positive event” and “events of second category” may refer to a “negative event.” It is to be noted herein that the terms “events of first category” and “positive event” and the terms “events of second category” and “negative event” may be interchangeably mentioned in the disclosure.

Embodiments of the present invention will be described below in detail with reference to the accompanying drawings.

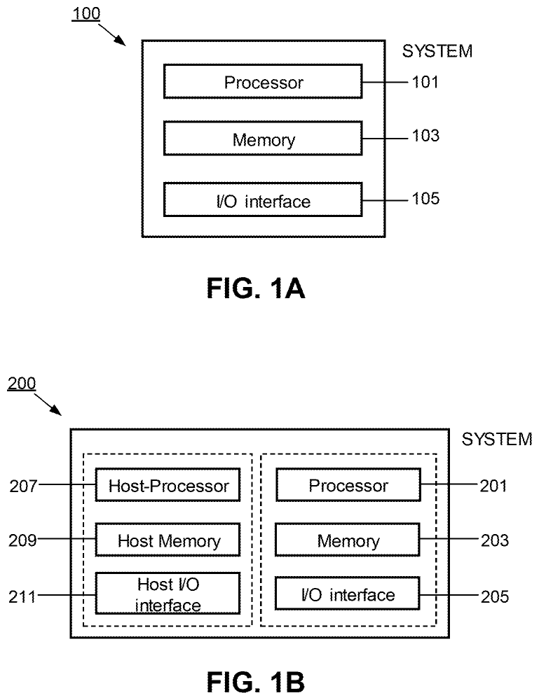

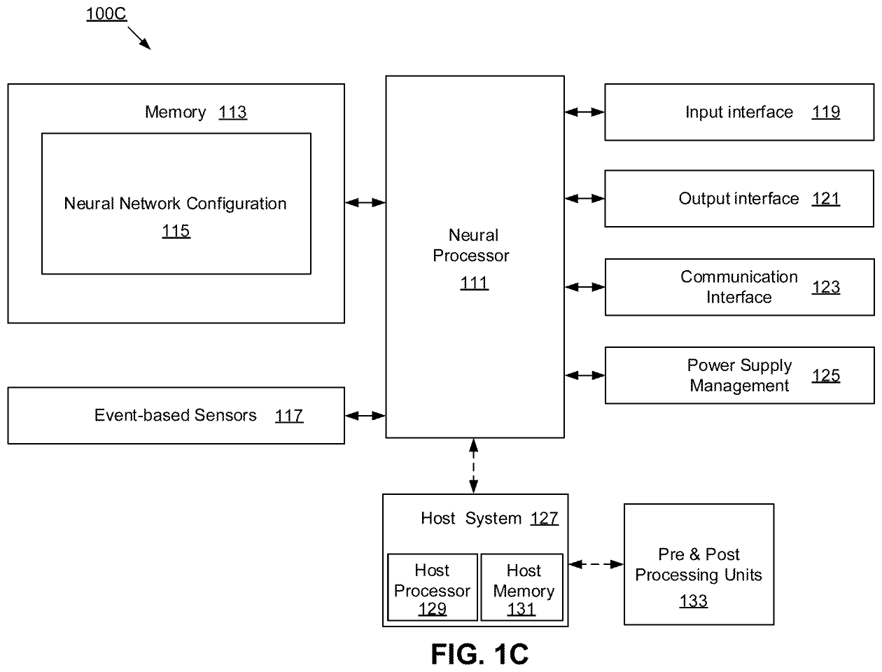

FIG. 1A illustrates an example system diagram of an apparatus configured to implement a neural network, in accordance with an embodiment of the disclosure. FIG. 1A depicts a system 100 to implement a neural network. The system 100 includes a processor 101, a memory 103, and an I/O interface 105.

The processor 101 can be a single processing unit or several units, all of which could include multiple computing units. The processor 101 is configured to fetch and execute computer-readable instructions and data stored in the memory 103. The processor 101 may receive computer-readable program instructions from the memory 103 and execute these instructions, thereby performing one or more processes defined by the system 100. The processor 101 may include any processing hardware, software, or combination of hardware and software utilized by a computing device that carries out the computer-readable program instructions by performing arithmetical, logical, and/or input/output operations. Examples of the processor 101 include but are not limited to an arithmetic logic unit, which performs arithmetic and logical operations, a control unit, which extracts, decodes, and executes instructions from a memory, and an array unit, which utilizes multiple parallel computing elements.

The memory 103 may include a tangible device that retains and stores computer-readable program instructions, as provided by the system 100, for use by the processor 101. The memory 103 can include computer system readable media in the form of volatile memory, such as random-access memory, cache memory, and/or a storage system. The memory 103 may be, for example, dynamic random-access memory (DRAM), a phase change memory (PCM), or a combination of the DRAM and PCM. The memory 103 may also include any non-transitory computer-readable medium known in the art including, for example, volatile memory, such as static random-access memory (SRAM), and/or non-volatile memory, such as read-only memory (ROM), erasable programmable ROM, flash memories, etc.

The I/O interface 105 includes a plurality of communication interfaces comprising at least one of a local bus interface, a Universal Serial Bus (USB) interface, an Ethernet interface, a Controller Area Network (CAN) bus interface, a serial interface using a Universal Asynchronous Receiver-Transmitter (UART), a Peripheral Component Interconnect Express (PCIe) interface, or a Joint Test Action Group (JTAG) interface. Each of these buses can be a network on a chip (NoC) bus. According to some embodiments, the I/O interface may further include sensor interfaces that can include one or more interfaces for pixel data, audio data, analog data, and digital data. Sensor interfaces may also include an AER interface for DVS pixel data.

FIG. 1B illustrates another example system diagram of an apparatus configured to implement the neural network, in accordance with an embodiment of the disclosure. FIG. 1B depicts a system 200 to implement the neural network. The system 200 includes a processor 201, a memory 203, an I/O interface 205, Host-Processor 207, a Host memory 209, and a Host I/O interface 211. The functionalities, operations, and examples associated with the processor 201, memory 203, and I/O interface 205 of the system 200 are similar to that of the processor 101, memory 103, and I/O interface 105 of the system 100 of FIG. 1. Therefore, a description of the same is omitted herein for the sake of brevity and ease of explanation of the invention.

The host-processor 207 is a general-purpose processor, such as, for example, a state machine, a high-throughput MIC processor, a network or communication processor, a compression engine, a graphics processor, a general-purpose computing graphics processing unit (GPGPU), an embedded processor, or the like. The processor 201 may be a special purpose processor that communicates/receives instructions from the host processor 207. The processor 201 may recognize the host-processor instructions as being of a type that should be executed by the host-processor 207. Accordingly, the processor 201 may issue the host-processor instructions (or control signals representing host-processor instructions) on a host-processor bus or other interconnect, to the host-processor 207.

The host memory 209 may include any type or combination of volatile and/or non-volatile memory. Examples of volatile memory include various types of random-access memory (RAM), such as dynamic random access memory (DRAM), synchronous dynamic random-access memory (SDRAM), and static random access memory (SRAM), among other examples. Examples of non-volatile memory include disk-based storage mediums (e.g., magnetic and/or optical storage mediums), solid-state storage (e.g., any form of persistent flash memory, including planar or three dimensional (3D) NAND flash memory or NOR flash memory), a 3D Crosspoint memory, electrically erasable programmable read-only memory (EEPROM), and/or other types of non-volatile random-access memories (RAM), among other examples. Host memory 209 may be used, for example, to store information for the host-processor 207 during the execution of instructions and/or data.

The host I/O interface 211 corresponds to a communication interface that may be any one of a variety of communication interfaces, but are limited to, such as a wireless communication interface, a serial interface, a small computer system (SCSI) interface, an Integrated Drive Electronics (IDE) interface, etc. Each communication interface may include a hardware present in each host and a peripheral I/O that operates in accordance with a communication protocol (which may be implemented, for example, by computer-readable program instructions stored in the host memory 209) suitable for this type of communication interface, as will be apparent to anyone skilled in the art.

FIG. 1C illustrates a detailed system architecture of the apparatus configured to implement the neural network, in accordance with an embodiment of the disclosure. FIG. 1C depicts a system 100C to implement the neural network. The system 100C includes a neural processor 111, a memory 113 having a neural network configuration 115, an event-based sensor 117, an input interface 119, an output interface 121, a communication interface 123, a power supply management module 125, pre & post processing units 133, and a host system 127. The host system 127 may include a host-processor 129, a host memory 131. The functionalities, operations, and examples associated with the components of the host system 127 are the same as that of the host-processor 207, memory 209 of the system 200. Therefore, a description of the same is omitted herein for the sake of brevity and ease of explanation of the invention.

The neural processor 111 may correspond to a neural processing unit (NPU). The (NPU) is a specialized circuit that implements all the necessary control and arithmetic logic necessary to execute machine learning algorithms, typically by operating on models such as artificial neural networks (ANNs) and spiking neural networks (SNNs). NPUs sometimes go by similar names such as a tensor processing unit (TPU), neural network processor (NNP), and intelligence processing unit (IPU) as well as vision processing unit (VPU) and graph processing unit (GPU). According to some embodiments, the NPUs may be a part of a large SoC, a plurality of NPUs may be instantiated on a single chip, or they may be a part of a dedicated neural-network accelerator. The neural processor 111 may also correspond to a fully connected neural processor in which processing cores are connected to inputs by the fully connected topology. Further, in accordance with an embodiment of the disclosure, the processor 101, 201, and the neural processor 111 may be an integrated chip, for example, a neuromorphic chip.

Also, examples of the memory 113 coupled to the neural processor 111 are the same as that of the memory examples described above with reference to the memory of FIG. 1A and FIG. 1C. The memory 113 may be configured to implement the neural network that includes a plurality of neurons at each of the convolution layer.

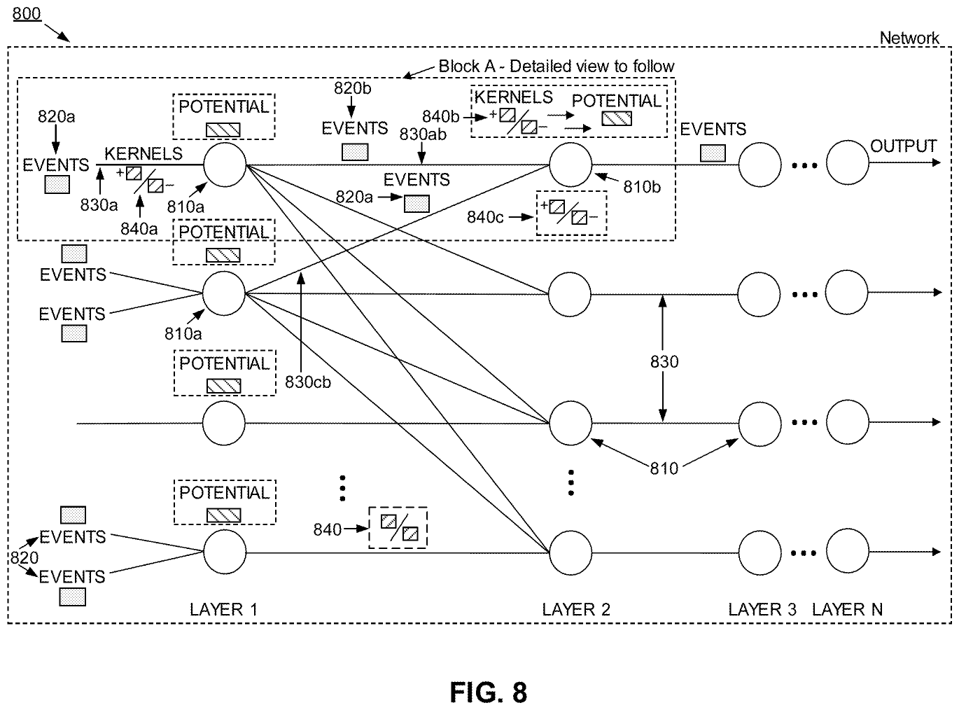

According to an embodiment, each of the neurons among the plurality of the neurons of each convolution layer is connected with one or more neurons of the next convolution layer using neural connections each having a specific connection weight and connection dynamics, meaning that it varies in time on its own after an event has been received. A detailed explanation of the neural connections of the neurons and the associated connection weight and dynamics are described below in the forthcoming paragraphs with reference to FIG. 8 of the drawings.

The input interface 119 is configured to receive a plurality of events associated with the event-based data over the one or more connections associated with the neuron. According to an embodiment, the event-based data is associated with one of spatial data, temporal data, and spatiotemporal data. According to a non-limiting example, the sequential data may include tensor data that may be received from an event-based devices like event-based cameras.

The output interface 121 may include any number and/or combination of currently available and/or future-developed electronic components, semiconductor devices, and/or logic elements capable of receiving input data from one or more input devices and/or communicating output data to one or more output devices. According to some embodiments, a user of the system 100C may provide a neural network model and/or input data using one or more input devices wirelessly coupled and/or tethered to the output interface 121. The output interface 121 may also include a display interface, an audio interface, an actuator sensor interface, and the like.

The event-based sensor 117 may correspond to a plurality of sensors including, but not limited to, a motion sensor, proximity sensor, accelerometer, sound sensor, light sensors, touch sensors and the like. The event-based sensors 117 capture and process data only when specific changes occur in the environment, according to Lebesgue sampling, which generates an event when a sensor analog value reaches a positive or threshold, generating, respectively a positive or negative event. Thus, the event-based sensors detect and respond to specific changes in sensor variables.

The communication interface 123 may comprise a single, local network, a large network, or a plurality of small or large networks interconnected together. The communication interface 123 may also comprise any type or number of local area networks (LANs) broadband networks, wide area networks (WANs), and a Long-Range Wide Area Network, etc. Further, the communication interface 123 may incorporate one or more LANs, and wireless portions and may incorporate one or more various protocols and architectures such as TCP/IP, Ethernet, etc. The communication interface 123 may also include a network interface to communicate via offline and online wireless communication with networks, such as the Internet, an Intranet, and/or a wireless network, such as a cellular telephone network, a wireless local area network (WLAN), personal area network, and/or a metropolitan area network (MAN). Wireless communication may use any of a plurality of communication standards, protocols, and technologies, such as LTE, 5G, beyond 5G networks, Wireless Fidelity (Wi-Fi) (such as IEEE 802.11, IEEE 802.11b, IEEE 802.11g, IEEE 802.11n, and/or any other IEEE 802.11 protocol), voice over Internet Protocol (VoTP), Wi-MAX, Internet-of-Things (IoT) technology, Machine-Type-Communication (MTC) technology, a protocol for email, instant messaging, and/or Short Message Service (SMS).

The pre-and-post-processing units 133 may be configured to perform several tasks, such as but not limited to reshaping/resizing of data, conversion of data type, formatting, quantizing, image classification, object detection, etc. whilst maintaining the same neural network architecture. The power supply management module 125 may be configured to supply power to the various modules of the system 100C.

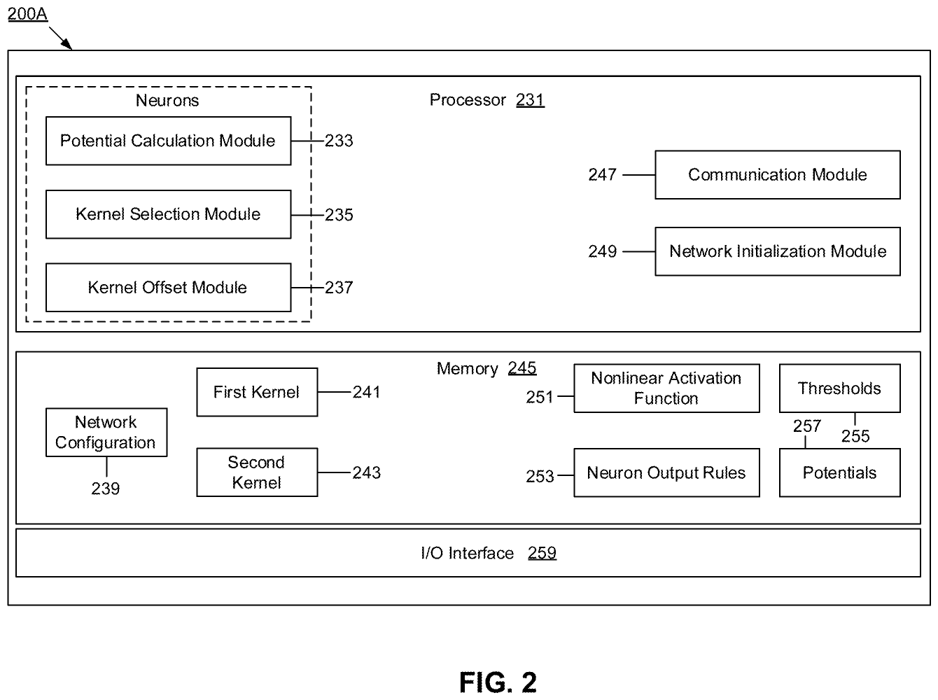

According to an embodiment of the disclosure, FIG. 2 illustrates a detailed system architecture of the apparatus configured to implement the neural network with reference to FIG. 1A to FIG. 1C. FIG. 2 depicts another system 200A to implement the neural network. The system 200A includes a neural processor 231 configured with a plurality of modules, a memory 245, and an input/output (I/O) interface 259. The functionalities, operations, and examples of the neural processor 231 are the same as that of the neural processor 111 and the functionalities, operations, and examples of the I/O interface 259 are the same as that of the I/O interface 105, 200, and 121 of the system 100, 200, and 100C, respectively. Therefore, a description of the same is omitted herein for the sake of brevity and ease of explanation of the invention.

In some embodiments, the system 200A may include one or more neural processors 231. Each neural processor 231 may be interconnected through a reprogrammable fabric. Each neural processor 231 may be reconfigurable. Each neural processor 231 may implement the neurons and their connections. Each neuron of the neural processor 231 may be implemented in hardware or software. A neuron implemented in the hardware can be referred to as a neuron circuit.

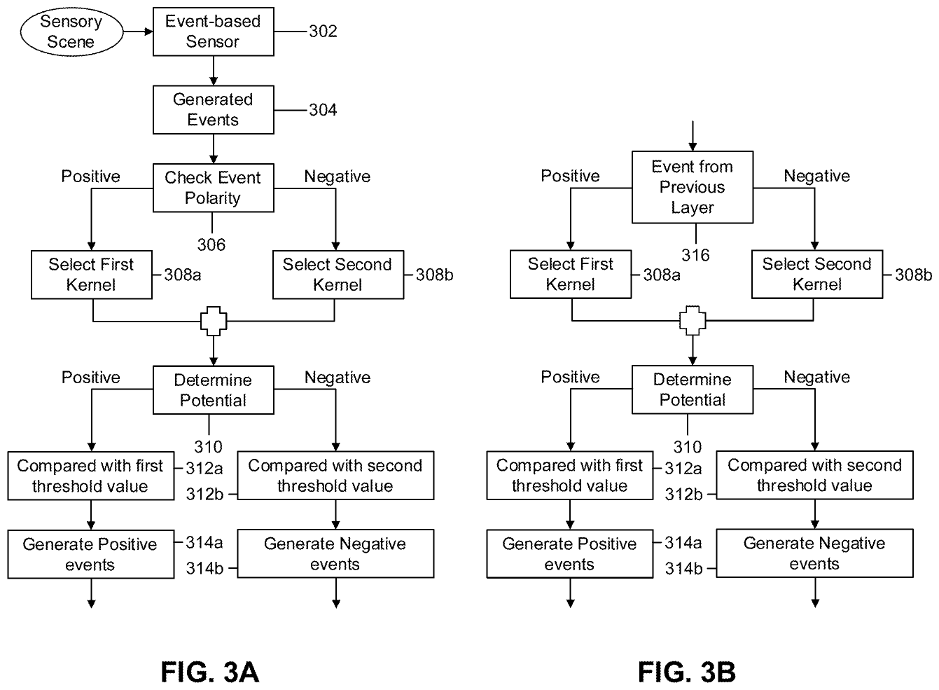

The memory 245 is comprised of a neural network configuration 239 that includes neurons in the layer (as shown in FIG. 8). The memory 245 is further comprised of a first kernel 241 and a second kernel 243. The working and description of the first kernel 241 and a second kernel 243 is given with respect to the FIG. 3A to 16. The memory 245 may be further configured to store a nonlinear activation value 251, neuron output rules 253, thresholds 255, and potential 257 associated with the neurons.

The neural processor 231 includes a plurality of modules comprising a potential calculation module 233, a kernel mode selection module 235, a kernel offset module 237, a network initialization module 249, and a communication module 247.

The potential calculation module 233 is configured to determine the potential values of the neurons based on the received plurality of events belong to a first category and a second category. The detailed explanation of the same is given in FIGS. 3A to 16.

The network initialization module 249 is configured to initialize weights of the neurons of the neural network configuration. Further, the network initialization module 249 is configured to initialize various parameters for the neurons, for example, neuron output rules, neuron modes, learning rules for the neurons, and initial potential value of the neurons and the like. Further, the network initialization module 249 may also configure neuron characteristics and/or neuron models.

The communication module 247 is capable of enabling communications between the neural processor and at least one of the I/O interfaces, host system, post-processing systems, and other devices over a communication network. Further, the communication module 247 is also capable of enabling read and write operations by application modules associated with memory 245. The communication module 247 may be configured to use any one or more communication technologies (e.g., wireless or wired communications) and associated protocols (e.g., Ethernet, Bluetooth®, Wi-Fi®, WiMAX, LTE, 5G, 5G-Advance, etc.) to enable such communication.

The kernel selection module 235 may be configured to perform operating mode selection for selecting first kernel and the second kernel depending upon the category of the event. Further, the kernel offset module 237 may be configured to provide an offset to the kernel. The working principle of selection of the kernel is explained with FIGS. 3A to 16 in the following paragraphs.

Reference is made to FIGS. 3A-3B that illustrates processing steps of a neuron within a neural network receiving events associated with event-based data. The event-based data may be associated with spatial data, temporal data, or spatiotemporal data. In some embodiments, the neuron may receive the events associated with the event-based data from an event-based sensor. For instance, the neuron may be in the first layer of the neural network and may be configured to receive events generated by the event-based sensor. In some embodiments, the neuron may receive the events associated with the event-based data from another neuron within the neural network, such as, another neuron in a previous layer within the neural network. For instance, the neuron may be positioned in a middle layer or a deep layer within the neural network and may be configured to receive events from one or more neurons of a previous layer.

As seen in FIG. 3A, at block 302, the event-based sensor may be configured to sense a sensory scene and generate event-based data based on the sensing of the sensory scene. The sensory scene may include scenes related to vision, auditory, tactile, taste, inertial motion, and the like. At block 304, the event-based sensor may be configured to generate a plurality of events associated with the event-based data. In some embodiments, the events may relate to increased presence or absence of one or more features of the event-based data, or decreased presence or absence of one or more features of the event-based data. In some embodiments, the events may be generated based on changes in values reaching thresholds associated with any data. For instance, considering an image, a change in pixel intensity values when compared to a predetermined threshold may or may not trigger a spike, or may generate a positive event or a negative event by reaching a positive threshold or a negative threshold, respectively.

In some embodiments, the information sensed by the event-based sensors may be processed based on Lebesgue sampling. For instance, in event-based sensors such as dynamic vision (DVS) sensors, once a pixel voltage reaches a particular threshold, the sensor emits a event, with negative polarization or positive polarization, at time tₖ. The generated event may correspond to a light intensity I reaching a specific value Iₖ, tₖ=t(Iₖ), k is an integer index k={0, 1, 2, . . . }. The values may be such that Iₖ₊₁−Iₖ=±ΔI, where the absolute value |Iₖ₊₁−Iₖ|=ΔI for all intervals k. The next (k+1)^{th} value for intensity Iₖ is given by either Iₖ₊₁=Iₖ±ΔI, respectively if the intensity increases (+) or decreases (−). The value ±ΔI may be taken as a threshold, which generates a an event (±) when the change in intensity reaches the threshold. A variable tracking the intensity change may be reset, to zero typically, after the emission of the generated event.

Referring back to FIG. 3A, at block 306, a polarity of the events being received at the neuron may be determined. Over a period of time, the neuron may be configured to receive the plurality of events over one or more corresponding connections, and each event received at the neuron may be associated with a corresponding category defining the polarity of the events. In some embodiments, each of the plurality of events may belong to a first category or a second category. In some embodiments, when an event of the plurality of events belongs to the first category, the event may be considered as a positive event. In some embodiments, when an event of the plurality of events belongs to the second category, the event may be considered as a negative event. Accordingly, the polarity of events may be defined based on whether the events belong to the first category or the second category. In some embodiments, when an event of the plurality of events belongs to the first category, the event may be associated with one of presence or absence of one or more features of the event-based data, and further, when an event of the plurality of events belongs to the second category, the event may be associated with other of presence or absence of one or more features of the event-based data.

In some embodiments, the neuron may be associated with one or more connections, and each connection may be associated with a first kernel and a second kernel. In some embodiments, the first and second kernels may be adaptive spatiotemporal kernels. In some embodiments, each of the first kernel and the second kernel may be represented as a sum over a set of basis functions. As described above, in some embodiments, the set of basis functions may be orthogonal polynomials, weighted by respective coefficients. In some embodiments, the respective coefficients may be determined during training of the neural network.

In some embodiments, the first and second kernels, for instance, adaptive spatiotemporal kernels, may be associated with a function having dimensions in space, time, and/or one or more other dimensions. In some embodiments, there is a multidimensional kernel including dimensions for differentially processing the polarity of events, i.e., positive polarity (positive event) or negative polarity (negative event), specifically when related to data generated from event-based sensors. In some embodiments, the other dimensions may include channels, polarization, frequency and phase, etc., based on a type of received input. In some embodiments, the dimensions over which the first and second kernels exist, and the associated values of the kernels, may be of finite dimensions. In some embodiments, the first and second kernels may be utilized for convolution operations over input data streams. In some embodiments, the first and second kernels may be parametrized using an expansion over basis functions, such as orthogonal polynomials, which may lead to faster training times.

At blocks 308A and 308B, for each of the events, one of the first kernel and the second kernel associated with the connection over which corresponding events are received may be selected. In some embodiments, selection of the first or second kernel may be based on the polarity of the corresponding events, in that, when an event of the plurality of events belongs to the first category, the first kernel may be selected and when an event of the plurality of events belongs to the second category, the second kernel may be selected. In some embodiments, the first kernel may be considered as a positive kernel and the second kernel may be considered as a negative kernel. In some embodiments, the positive kernel may be different from the negative kernel, in that, the positive kernel may be a different function as compared to the negative kernel.

The events being processed at the neuron may indicate a positive change (+1, positive event), no change (0, no event), negative change (−1, negative event) of an internal potential value. This is different from existing SNNs that uses spikes which are either absent (0, no spike) or present (1, spike). In addition, the present disclosure relates to events which may be encoding events using a positive change (+a) and negative change (−b) where a and b may take any value, for example, they may take the values of respective thresholds. In some embodiments, the values a and b may not be uniform in space and/or constant in time.

In some embodiments, the selected kernels may be processed in order to determine the potential at the neuron. As described above, a plurality of events may be received at the neuron over a period of time, and thus, the potential at the neuron may be determined over the period of time. In some embodiments, the potential at the neuron may be a dynamic potential, in that, the potential at the neuron may vary over the period of time based on the events being received at the neuron and the processing of the kernels when the events are received at the neuron.

As an example, considering that the event-based data may be associated with temporal data, the plurality of events may be received at the neuron at different time instances, i.e., a first event may be received at the neuron at first time instance, a second event may be received at the neuron at second time instance, and so on. When the first event is received at the neuron, an associated kernel, say, kernel 1 may be selected based on polarity of the first event. The potential of the neuron at the first time instance may be determined based on processing of the kernel 1. When the second event is received at the neuron, an associated kernel, say, kernel 2 may be selected based on polarity of the second event. The potential of the neuron at the second time instance may be determined based on processing of the kernel 2 along with the earlier potential, i.e., potential based on kernel 1. In some embodiments, processing of the kernels may include offsetting the kernels in one of temporal, spatial, or spatiotemporal dimension, and further, summing the offset kernels to determine the potential. The offsetting of the kernels is described in detail further below in the present disclosure. In the present example, at any particular time instance, say second time instance, the kernel 2 may be offset with respect to the kernel 1 in the temporal dimension based on the time of arrival of the associated events (first time instance for first event and second time instance for second event). The offset kernels may then be summed to determine the potential at the neuron at the second time instance.

In a similar manner, potential at different time instances may be determined based on offsetting of the kernels associated with the received events and summation of the offset kernels, as also described further below in the present disclosure. In some embodiments where the events may be associated with spatial data, the associated kernels may be offset based on position of a neuron sending the events.

As depicted in FIG. 3A, at block 310, the potential at the neuron may be determined based on processing of the kernels associated with the received events. Over the period of time when the events are received at the neuron, a dynamic potential may be achieved at the neuron, i.e., a potential that may vary over the period of time when the events are received at the neuron. Further, at block 310, it may be determined whether the determined potential is associated with a positive value or a negative value. As described above, for each event, either the first kernel or the second kernel may be selected based on polarity of the received event. Further, the selected kernels may be offset in a spatial, temporal, or spatiotemporal dimension, and summed to determine the potential. Accordingly, based on the selected kernels being first kernels or second kernels, and further based on amount of offset of the selected kernels, the determined potential may either be associated with a positive value or a negative value. Skilled artisans would appreciate that a majority of selected kernels being second kernels (say, negative kernels) does not necessarily lead to the potential being associated with a negative value, and similarly, a majority of selected kernels being first kernels (say, positive kernels) does not necessarily lead to the potential being associated with a positive value.

Based on the determined potential, output at the neuron may be generated. When the determined potential is associated with a positive value, the determined potential may be compared with a first threshold value, as depicted at block 312A. When the determined potential is associated with a negative value, the determined potential may be compared with a second threshold value, as depicted at block 312B. In some embodiments, the first threshold value may be a positive value and the second threshold value may be a negative value. The output at the neuron may be generated based on the comparison of the determined threshold with one of the first threshold value or the second threshold value. In some embodiments, the first threshold value and the second threshold value may not be uniform in space and/or constant in time.

At blocks 314A and 314B, output of the neuron may be generated, the output being associated with one of positive events or negative events. When the determined potential is compared with the first threshold value, and the determined potential may be greater than the first threshold value, then positive events may be generated as shown at block 314A. When the determined potential is compared with the second threshold value, and the determined potential may be lesser than the second threshold value, then negative events may be generated as shown at block 314B. The generated positive events or negative events may be sent to a next layer within the neural network, in particular, to one or more other neurons in the next layer within the neural network. As described above, both types of kernels, i.e., positive and negative kernels, may be available for processing based on the polarity of the received events. As a result, a much faster processing of the event-based data is achieved.

The present disclosure may thus generate positive (+1) and negative events (−1) when a positive and negative threshold is reached, respectively. In contrast, SNNs merely have a membrane potential which generates a spike (1) when a threshold is reached. In some embodiments, a large threshold value may be provided, such as a large negative threshold. In such an embodiment, the neuron in the disclosed systems may, thus, generate only positive events, similar to spikes generated in SNNs. Going beyond SNNs, the present disclosure generalizes into spaces of higher internal dimensions as well where the number of thresholds may be greater than 2, such as for complex-valued potentials.

In some embodiments, the neuron may be configured to receive events from one or more previous neurons, i.e., neurons in a previous layer within the neural network. Referring to FIG. 3B, at block 316, the neuron may receive events from a previous layer rather than receiving events from an event-based sensor. For instance, the neuron may be positioned in a deep layer within the neural network. Further, the steps at blocks 308A-308B, 310, 312A-312B, 314A-314B are similar to those mentioned for FIG. 3A and have not been repeated for sake of brevity. Thus, it is evident from FIG. 3B that neuron to neuron connections are provided within the neural network and the events communicate across neurons within the neural networks. The events may thus be considered as propagating within the neural network. Moreover, it is the events, characterized by arrival times, address of neurons, and polarity of events, that are communicated within the neuron network rather than an analog output value of the potential of neuron.

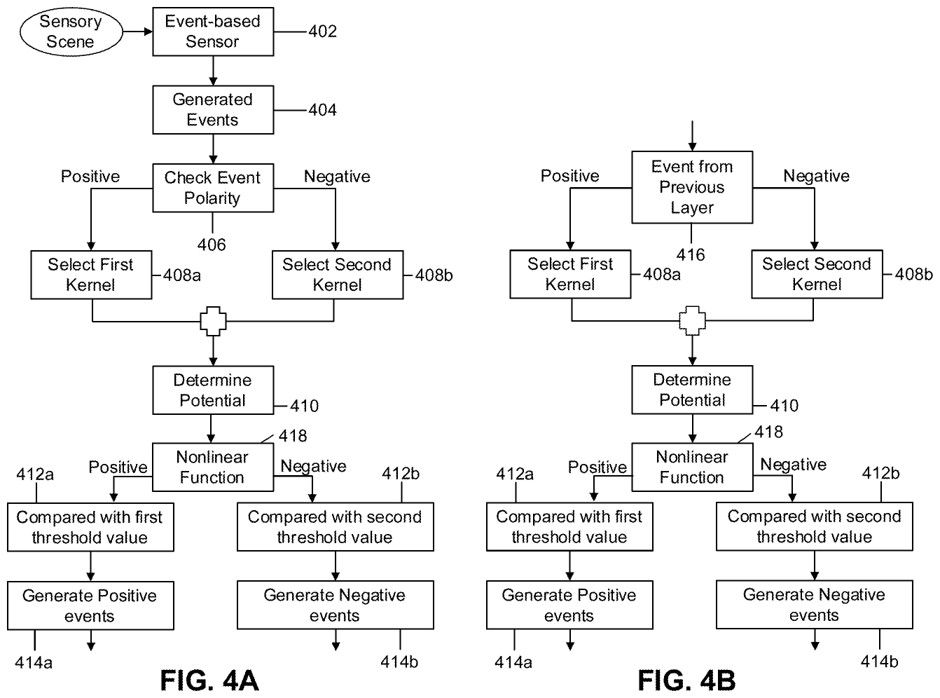

In some embodiments, prior to comparing the determined potential with the first threshold value or the second threshold value, an intermediate value may be generated. Referring to FIG. 4A, at step 418, prior to comparing the determined potential with the first threshold value or the second threshold value, the determined potential may be provided to a nonlinear function in order to introduce nonlinearity into the neural network. The determined potential may be processed based on the nonlinear function so as to generate an intermediate value. In some non-limiting embodiments, the nonlinear function may be sigmoid, tanh, ReLu, leaky ReLu, Maxout, ELU, and the like. Accordingly, the intermediate value may represent an output of the determined potential processed based on the nonlinear function, based on the polarity of the events being received at the neuron, and further based on the kernels associated with the received events, the determined intermediate value may either be associated with a positive value or a negative value.

Further, at steps 412A and 412B, the intermediate value may be compared with the first threshold value, or the second threshold value based on the polarity of the intermediate value. At blocks 414A and 414B, one of positive events or negative events may be generated that are propagated further within the neural network. Skilled artisans will appreciate that the blocks 402, 404, 406, 408A-408-B, and 410 are analogous to blocks 302, 304, 306, 308A-308-B, and 310 of FIG. 3A, and the details have not been repeated herein for sake of brevity.

In some embodiments, as shown in FIG. 4B, the neuron may be configured to receive events from one or more previous neurons, i.e., neurons in a previous layer within the neural network. In particular, at block 416, the neuron may receive events from a previous layer rather than receiving events from an event-based sensor. Further, based on the polarity of the received events, the steps at blocks 408A-408B, 410, 418, 412A-412B, and 414A-414B may be performed, analogous to the manner as described with reference to FIG. 4A, and the details have not been repeated herein for sake of brevity.

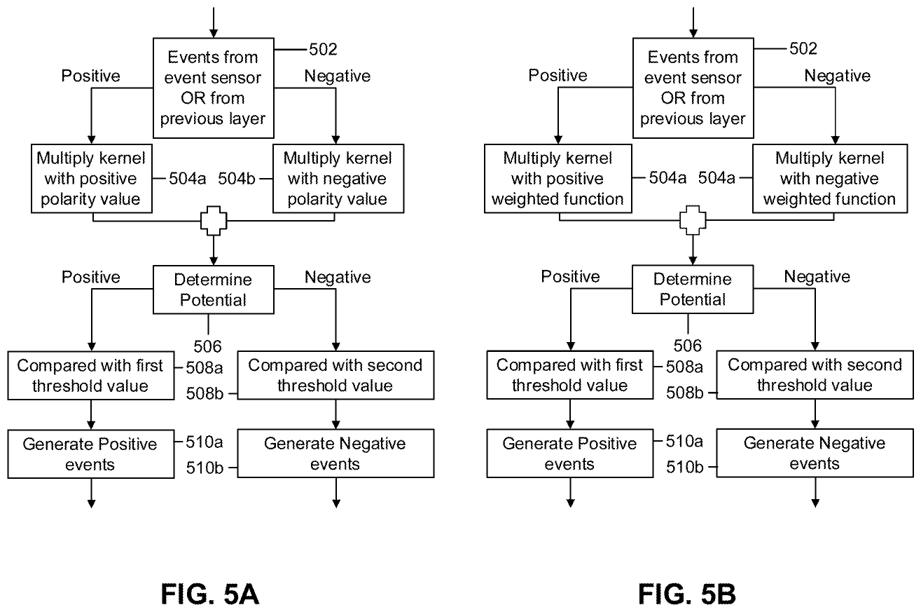

In some embodiments, the first kernel and the second kernel may be associated with a common kernel, in that, the first kernel and the second kernel may be derived from the common kernel. Referring to FIG. 5A, at blocks 504A and 504B, kernels for determining the potential at the neuron may be generated based on the polarity of the received events. The kernels may be derived from a common kernel based on the polarity of the received events. Accordingly, separate kernels for events of first category (say, positive events) and events of second category (say, negative events) may not be required. In some embodiments, a positive polarity value and a negative polarity value may be provided and the common kernel may be multiplied by one of the positive polarity value or negative polarity value. As an example, for events of first category (say, positive events), the positive polarity value may be considered as +1 and for events of second category (say, negative events), the negative polarity value may be considered as −1. In other words, when the polarity of the received events is determined to be positive, then the common kernel may be multiplied by the positive value, as depicted at block 504A, and when the polarity of the received events is determined to be negative, then the common kernel may be multiplied by the negative value, as depicted by block 504B. Accordingly, the determined negative kernel may thus be considered as minus the determined positive kernel or vice versa.

In some embodiments, the first kernel and the second kernel may be based on weighted factors of a common kernel. For instance, referring to FIG. 5B, at blocks 504A and 504B, the first kernel and the second kernel may be derived from the common kernel based on a positive weighted function or a negative weighted function. When the events received at the neuron belong to the first category (say, positive events), the kernel may be derived based on a positive weighted function and when the events received at the neuron belong to the second category (say, negative events), the kernel may be derived based on a negative weighted function. Accordingly, based on the polarity of the received events, the kernels may be generated for determining the potential at the neuron. Accordingly, the determined negative kernel may thus be considered as a weighted factor of the determined positive kernel or vice versa.

Further, the steps at blocks 502, 506, 508A-508B, and 510A-510B may be performed, which are analogous to blocks 310, 312A-312B, and 314A-314B of FIGS. 3A-3B, and the details have not been repeated herein for sake of brevity. Although FIGS. 5A-5B depict the determined potential being compared with positive threshold value or negative threshold value, in some embodiments, additional block of nonlinearity may be provided to generate an intermediate value that is compared with the positive threshold value or negative threshold value, as also described with reference to FIGS. 4A-4B.

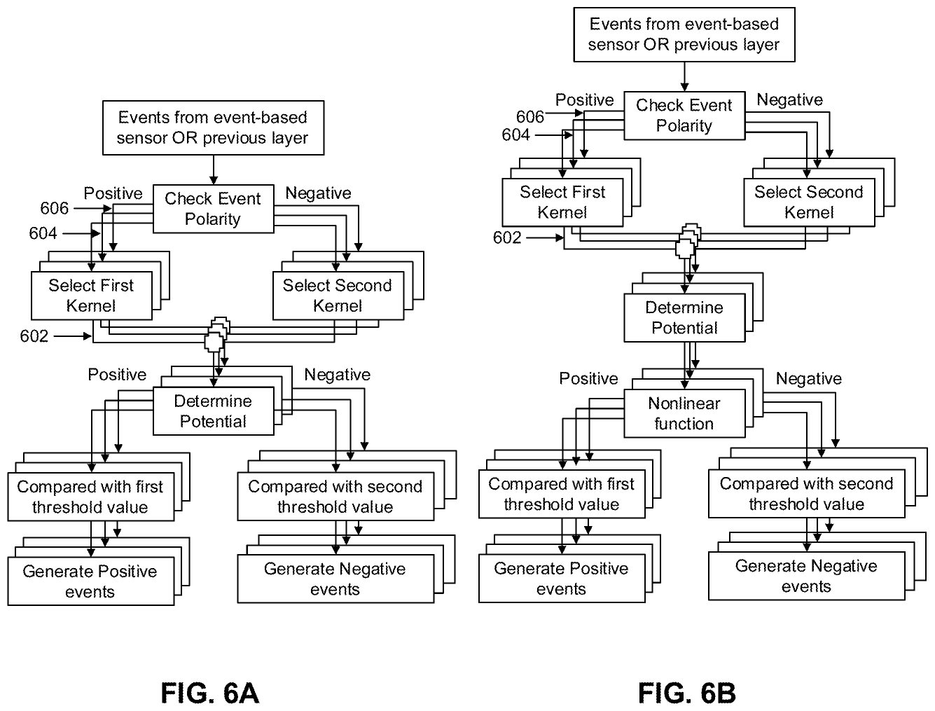

In some embodiments, the neural network may comprise more than one channel. As a non-limiting example, the event-based sensor may project to more than one neuron in the first layer of the neural network. In some embodiments, each channel of a layer within the neural network may be associated with the channels of the next layer and vice versa. Referring to FIGS. 6A and 6B, processing steps of a neuron receiving events associated with event-based data are illustrated, the processing steps shown in FIG. 6A being analogous to the processing steps described with reference to FIG. 3A and the processing steps shown in FIG. 6B being analogous to the processing steps described with reference to FIG. 4A. As seen in FIGS. 6A and 6B, multiple channels may be provided, shown by arrows 602, 604, and 606. In some embodiments, each channel 602, 604, 606 may receive the same events, however, each channel 602, 604, 606 may be associated with a different first kernel and a different second kernel. Accordingly, for each channel 602, 604, 606, one of the first kernel and second kernel is selected based on the polarity of the events, and the selected kernels are then processed to determine the potential at the neuron. In some embodiments, the selected kernels associated with the same input neurons or different input neurons may be summed in order to determine the potential. In some embodiments, the polarity of the received event may be communicated through same channel neurons or different channel neurons. Although channels 602, 604, and 606 are depicted in FIGS. 6A-6B, it is appreciated that that there may be any number of channels associated with the neurons within the neural network.

In some embodiments, the received events, such as events associated with spatiotemporal data, when processed based on a kernel transform into analog values from digital values on the basis of the equation (1):

$$u ( x , y , t ) = {\sum }_{p q k} h ( x - p , y - q , t - {t}_{k} ) \{ ( {p}_{k} , {q}_{k} , {t}_{k} ) \} = ( h * ) ( x , y , t ) \qquad ( 1 )$$

where (h* [symbol] ) indicates a convolution, h(x−p,y−q,t−tₖ) is the spatiotemporal kernel, which acts on timed-events [symbol] (pₖ,qₖ,tₖ) at the positions pₖ and qₖ. The notation { [symbol] (pₖ,qₖ,tₖ)} is used to indicate an entire set of events generated from the event-based sensors at times tₖ and positions (pₖ,qₖ). In other words, notation { [symbol] (pₖ,qₖ,tₖ)} represents all the events from the inputs and within the networks and specifies that they occur at time tₖ and location (p=pₖ,q=qₖ) for all k. It is to be noted herein that the values of the neurons' potential may not be transmitted within the network, rather, the timestamp of the events, along with polarity Pₖ, together with its point of origin in the network is being propagated within the network. Further, as described above and as would be evident from the disclosure, the term ‘offset’ does not include mere shifting of kernels, rather, the term ‘offset’ also includes transforming kernel based on timing information.

In some embodiments, the kernel offset may be computed globally through the kernel coefficients, which represents the kernel projection onto the basis functions, such as orthogonal polynomials. Just like two vectors, expressed in the same coordinate system, can be added by adding their respective coefficients, so two kernels can be added by adding their kernel coefficients when both kernels are expressed in the same expansion basis. This is particularly simple when the coordinate systems, or basis functions are orthogonal, such as in the case of orthogonal polynomials, and the Legendre polynomials. Given say two events occurred at two different times, the goal is to perform the sum of the kernels centered at these two events, by taking the latest event as the point of reference, then compute new coefficients for the other kernel that is shifted (offset) in time by the time difference between the two events. The resulting expression will be valid for all times, past and future, within the interval of definition of the polynomials being used as a basis.

Assuming that the latest input event to a neuron occurred at time tₖ with kernel B and the penultimate event was at time tₖ₋₁ with kernel A, in some embodiments, the latest event is chosen as the reference point, chosen because in practice many kernels have a finite support, that is a finite interval over which they are defined. As events become older, it will come a time at which such old events will no longer contribute to the neuron potential and therefore can be ignored, whereas the most recent event in general may not be ignored.

The kernel coefficients,

$${α}_{l}^{B} ( 0 ) ,$$

define the shape of the kernel B at the time tₖ of the event, that is at time t−tₖ=0, with a support up to time t−tₖ=T in the future, 2T being the time period over which the kernel is defined. In order to be used with Legendre polynomials, the time is normalized to maintain a value between, say,

$$\frac{( t - {t}_{k )}}{T} = - 1 and \frac{( t - {t}_{k )}}{T} = 1 ,$$

which defines an interval [−T, +T] around the last event tₖ. In order to sum the kernels, the kernel with coefficients centered for the event tₖ₋₁, must now be offset by the time difference of tₖ−tₖ₋₁ towards the past of the reference point, thus −tₖ₋₁/T to the past of event tₖ, which is now the new reference point. Thus, from the previous coefficients,

$${α}_{l}^{A} ( 0 ) ,$$

and given a specific basis functions, such as the Legendre polynomials Pₗ(θ), new coefficients,

$${α}_{l}^{A} ( - {t}_{k - 1} / T )$$

may be computed from knowing the original coefficients,

$${α}_{l}^{A} ( 0 ) ,$$

the polynomials Pₗ(θ) and the desired offset

$$- \frac{{t}_{k - 1}}{T} .$$

Having find an expression for the offset kernel in the same coordinate system as the latest event, one can add the coefficients together, just like the coordinates of vectors, to find the sum of the kernels, and thus, for each basis function of order l, the sum will involve the coefficient of the kernel B at zero plus the coefficient of the offset, or shifted kernel, A, such as

$${α}_{l}^{B} ( 0 ) + {α}_{l}^{A} ( - {t}_{k - 1} / T ) .$$

Such methods provide for an expression of the sum of the kernels for all time in the interval [−T, +T] at once, without further computation, hence its efficiency. Given that the sum of two different kernels centered at two events can be computed, so can the sum of a plurality of kernels centered at their respective events.

In some embodiments, other methods may be used to compute the sum of the kernels centered at their respective events. One method, which may be used in some embodiments, is a numerical method that computes explicitly for each event involved and for each specific time of interest the sum of the kernels centered at their respective events. Given the same two events as presented in the previous two paragraphs, the sum of the kernels would be given numerically by h_{B}(t−tₖ)+h_{A}(t−tₖ−tₖ₋₁), or with the time interval normalized to be used with the Legendre polynomials, h_{B}((t−tₖ)/T)+h_{A}((t−tₖ−tₖ₋₁)/T), where each kernel is expressed as the expansion over the Legendre polynomials,

$${h}_{t} ( θ ) = {\sum }_{l = 0}^{r} {α}_{l} {P}_{l} ( θ ) ,$$

each kernel being expressed by its own set of coefficients aₗ. Here, because the polynomials are not centered around the same point of reference, the two kernels do not use the same basis functions (the same polynomials) and thus, the coefficients cannot be added as in the previous method to find the sum of the kernels. The kernel values at specific point in time expressed using the same time axis in the numerical computations, they, can be added together to find the sum of the kernels.

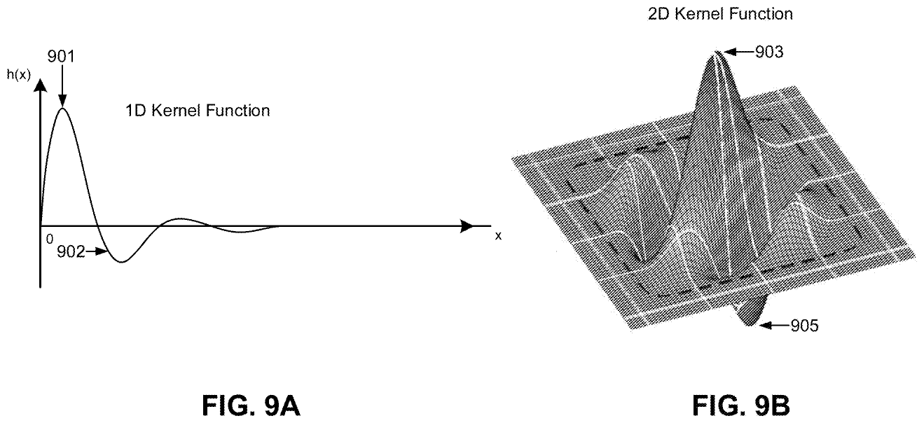

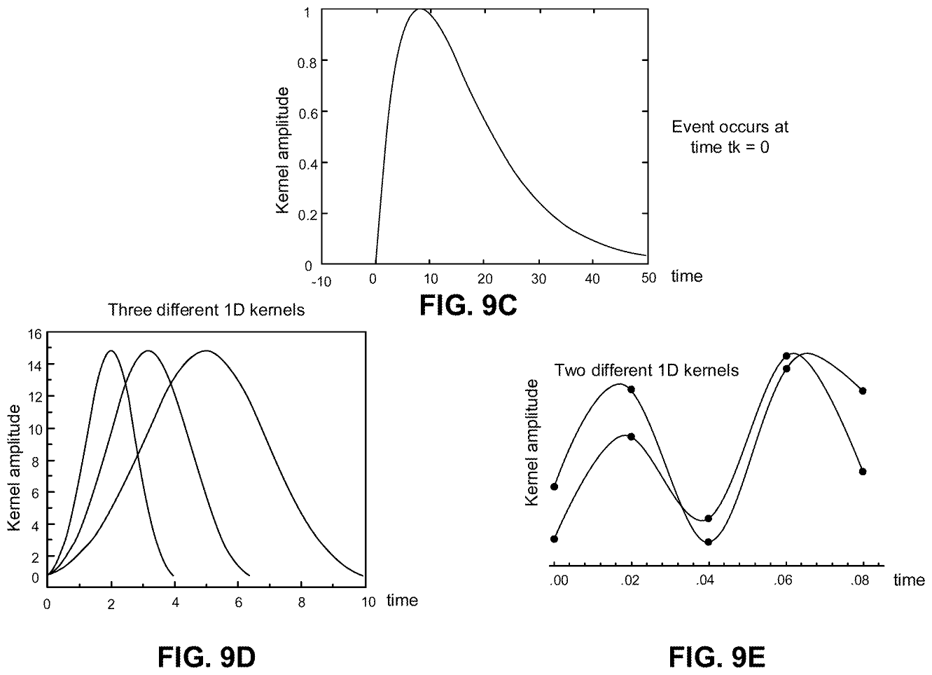

FIG. 9A depicts an exemplary response of the potential to the convolution of a 1D kernel to an event at a postsynaptic neuron. The convolution by the kernel over an event is simply the kernel centered at the time and location of the event. In the context of kernel functions, a 1D kernel function refers to a function that operates on one-dimensional input data. As can be seen in FIG. 9A, a single event, if the arbitrary dimension x is time t, produces a dynamical response in time of the neuron's potential which may take on positive values 901 followed by negative values 902 in some arbitrary fashion solely defined by the temporal kernel, which is a result of the values of corresponding kernel coefficients over its basis functions, as detailed further below.

In the case of FIG. 9A representing a spatial kernel, the kernel represents the response of all the neurons in the postsynaptic layer that would receive a single event from a presynaptic neuron. In one embodiment, the arbitrary x value is determined by the relative position of the postsynaptic neuron, referred to as x again, relative to the position of the presynaptic neuron emitting the event k, referred to with the title pₖ. Thus, the relative position is given by x−pₖ. Given the value of x−pₖ, such value along the x-axis of FIG. 9A may define the value of the kernel h(x−pₖ), which is the value to assign to the spatial component of the connection between the postsynaptic neuron at the position x and the presynaptic neuron emitting the event at the position pₖ. As the value of x changes over all the possible positions of neurons in the postsynaptic layer, the values (x−pₖ) go from 0 to a maximum value, and further, the connectivity between one presynaptic neuron and each of the postsynaptic neurons is represented by the spatial kernel mapped onto the neurons of the postsynaptic layer.

In some embodiments, the connection between two neurons within the neural network may be represented by one or more spatial kernel(s) and a temporal kernel multiplying each other. Thus, the connectivity of a presynaptic neuron to every postsynaptic neurons may be given by the multiplication of the temporal kernel found above in the first temporal interpretation of FIG. 9A by the spatial kernel found in the second spatial interpretation of FIG. 9A. In some embodiments, the spatial and temporal kernel may be arbitrarily different from each other.

FIG. 9B-9E illustrates examples of kernels associated with the response of neurons to a single event within the neural network, according to an embodiment of the present disclosure. FIG. 9B depicts an example response of an event from a presynaptic neuron projecting spatially to a 2D layer of postsynaptic neurons. The 2D kernel represents the connectivity between the presynaptic neuron and each neuron in the postsynaptic layer. In the illustrated embodiment, the 2D spatial kernel in FIG. 9B is a specific Gabor filter. In general, the 2D kernel function refers to a function that operates on two-dimensional input data. The connectivity values represented by the kernel may take in arbitrary fashion positive values like 903 as well as negative values like 905. The kernel depicted in FIG. 9B may be a kernel associated with spatial data processing. In some embodiments where spatiotemporal data is to be processed, the kernel may be a multidimensional kernel. The multidimensional kernel may be a 3D kernel with, for example, 2 spatial dimensions and one temporal dimension. The multidimensional kernel may be a 4D kernel with, for example, 2 spatial dimensions, one temporal dimension and one channel dimension. It is appreciated that the multidimensional kernel may include an arbitrary number of dimensions, depending on the structure of the network and the data that the multidimensional kernel processes.

Other forms for the temporal kernel are possible, such as a decaying function, or a sharp rise followed by a decreasing exponential, or a concave function with a single peak, where the peak location may vary, or a function with multiple peaks, or arbitrary weighted sum of orthogonal polynomial, etc.

FIG. 9C-9E illustrates various examples of temporal kernels that may be represented with embodiments of the present invention.

The systems disclosed herein describe kernels that can be expressed through partial differential equations or as spatiotemporal kernels, involving both spatial and temporal components. These spatiotemporal kernels can have positive and negative effects on the potential and are not arbitrarily predetermined, such as in SNNs. The positive and negative regions of the kernels can be positioned anywhere along the spatial or temporal axes. SNNs are often described using differential equations or temporal kernels that have positive or negative effects on the membrane potential of excitatory or inhibitory neurons. A refractory kernel, acting as an inhibitory kernel, can be added to the potential after a spike is generated to prevent immediate subsequent spiking. The selection of SNN's temporal and refractory kernels is typically heuristic, and certain parameters like weights and time constants can be trained through learning processes. Unlike SNNs, where kernels are typically chosen arbitrarily, the disclosed systems in some embodiments allow for the training of kernels. This means that the kernels can be learned through training processes. Additionally, in certain embodiments, a post-event kernel can be trained to facilitate or inhibit the generation of subsequent events, influencing the potential of the unit after an event has been generated. The post-event kernel may be embodied in a recurrent connection of the neuron output to an input to itself. In this embodiment, the post-event kernel may be trained in the same manner as any of the other temporal kernels representing the dynamics of the responses from inputs coming from other neurons.

In some embodiments, the kernels may be referred to as h(x) for a 1D spatial kernel, h(x, y) for a 2D spatial kernel, h(x, y, t) for a 3D spatiotemporal kernel, and so on. In some embodiments, the kernels may be separable kernels. As an example, considering a 3D spatiotemporal kernel h(x, y, t), the 3D kernel may be obtained based on multiplication of a 2D spatial kernel h(x, y) with a 1D temporal kernel h(t), as shown below by equation (2):

$$h ( x , y , t ) = h ( x , y ) h ( t ) \qquad ( 2 )$$

In some embodiments, considering a 3D kernel h(x, y, t), the 3D kernel may be obtained based on multiplication of 1D kernels with each other, as shown below by equation (3):

$$h ( x , y , t ) = h ( x ) h ( y ) h ( t ) \qquad ( 3 )$$

In some embodiments, the kernels may be represented as a sum over a set of basis functions. In some embodiments, the basis functions may be orthogonal polynomials. For instance, if Tₙ(x) is a set of basis functions and aₙ is a coefficient, then a 1D kernel may be represented based on the equation (4):

$$h ( x ) = {\sum }_{n = 0}^{∞} {a}_{n} {T}_{n} ( x ) \qquad ( 4 )$$

Considering approximations of partial (or truncated) sums up to a degree r, the 1D kernel may be represented based on the equation (5):

$$h ( x ) = {\sum }_{n = 0}^{r} {a}_{n} {T}_{n} ( x ) \qquad ( 5 )$$

Considering a multidimensional kernel, such as a 3D kernel, having dimensions x, y, and t, the 3D kernel may be represented based on the equation (6):

$$h ( x , y , t ) = {\sum }_{n = 0}^{∞} {a}_{n} {T}_{n} ( x , y , t ) \qquad ( 6 )$$

As described above, in some embodiments, a multidimensional kernel may be achieved by multiplying 1D kernels with each other. For instance, considering a 2D kernel, the 2D kernel may be obtained based on the equation (7):

$$h ( x , y ) = {\sum }_{n = 0}^{r} {a}_{n} {T}_{n} ( x ) {\sum }_{n = 0}^{r} {b}_{n} {T}_{n} ( y ) \qquad ( 7 )$$

where the partial sums may be the same or may contain different number of elements. In other words, the value for r may be different in both sums.

One major challenge when dealing with time series data is the need to evaluate a kernel at numerous points along the time axis. For instance, in applications like speech or audio processing, the time series data are sampled at a rate of 16,000 Hz, thousands or even millions of points may need to be considered.

The conventional approach to handle this involves assigning one weight to each timebin, resulting in a high cost for representing the kernel in temporal convolution. Furthermore, this approach requires training a large number of parameters for each neuron, which becomes impractical when considering the number of neurons in a network. Consequently, temporal convolutional neural networks are not widely used in practice.

To illustrate the scale of the issue, consider a neural network with a million neurons. In such a scenario, the number of parameters to train would already amount to an enormous figure: say, 100 timebins per connection with 100 connections per neuron, this would mean a significantly high number of parameters. In summary, the challenge of evaluating kernels at numerous time points, along with the high parameter count associated with temporal convolutional neural networks, presents significant obstacles in dealing with time series data.

According to some embodiments, the kernels, including the spatial, temporal or spatiotemporal kernels, in the neural network may be represented as an expansion over some functions, such as:
a. Complete set of (basis) functions
b. Overcomplete set of (basis) functions
c. Orthogonal set of basis functions
d. Orthogonal set of basis functions over a finite interval
e. The complete set of basis functions being polynomials
f. Orthogonal polynomials
g. Orthogonal polynomials over a fixed support (interval over the input dimension)
h. Orthogonal Jacobi polynomials, which include as special cases orthogonal Chebyshev polynomials, orthogonal Legendre polynomials, and orthogonal Gegenbauer polynomials
i. Other Orthogonal Polynomials on a finite interval.
j. Or alternatively, with parametrized (partial) differential equations that may be obtained from taking the (partial) derivative(s) of the parametrized spatiotemporal kernels that are the Green's function solution(s) of these differential equations. The spatiotemporal kernels and their associated differential equations represent similar entities expressed using different formulations.

In accordance with an embodiment, the spatial, temporal or spatiotemporal kernels in the neural network may be represented as one of a weighted sum of basis functions, including polynomials, and orthogonal polynomials. Thus, the disclosed kernels may be represented by the coefficients weighting the basis functions along with their basis function. Accordingly, the kernels are expressed as an expansion over basis functions, which is a weighted sum of basis functions. The mathematical equation for the kernels represented as sum of basis functions is given by equation (5) above.

In an embodiment, for determining the potential of the neuron, the convolution is performed by using the kernels on the received input I(t). Accordingly, when the input I(t) is received, the neural processor may be configured to perform the convolution, through the neural network layers, based on a weighted sum of convolution of the input I(t) with each basis function independently. In an embodiment, the weights in the weighted sum of convolution are the kernel coefficients. Accordingly, as the input I(t) received as an event, the convolution of the kernel with the input becomes the kernel centered at the event. Thus, with a series of events as the input, the convolutions of the kernel with the events become the sum of the kernels centered at each event.

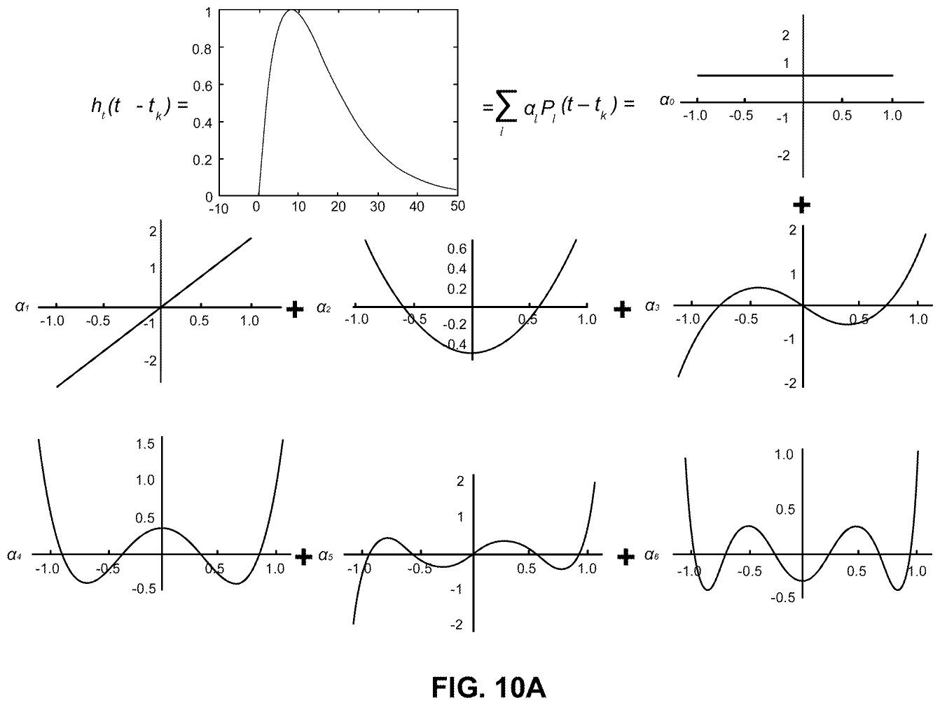

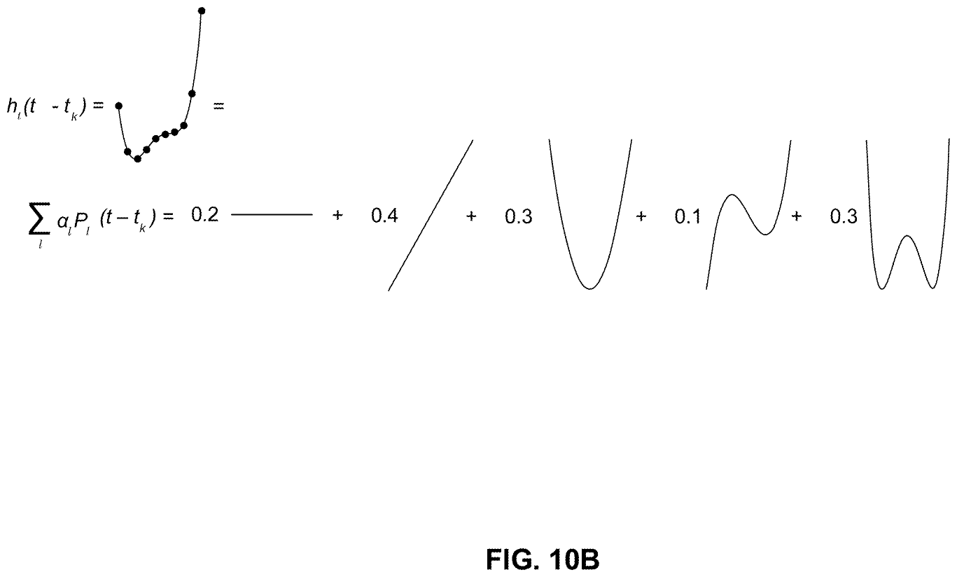

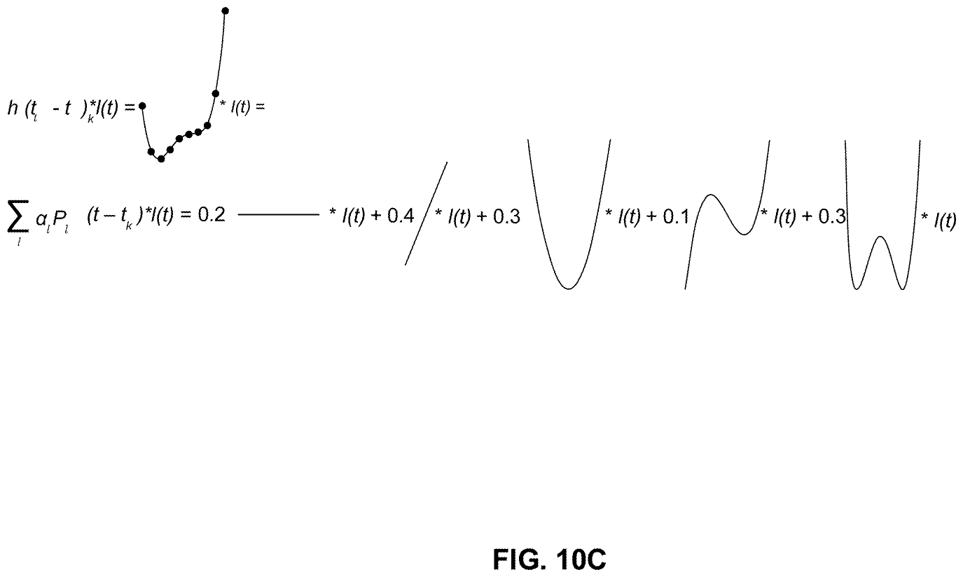

The representation of the kernel as the expansion over basis functions, such as orthogonal polynomials, enables the shape of the kernel to be represented efficiently. For example, the kernels may be represented in a compact form which makes a chip implementation practical. FIGS. 10A-10C illustrate various examples of kernel expansions and kernel convolution operations.

In particular, FIGS. 10A-10B illustrate various examples of kernel representations based on an expansion over basis functions, according to an embodiment of the present disclosure. The kernel is represented by a finite sum of alpha coefficients multiplying a series of basis functions, here the orthogonal Legendre polynomials, presented for illustration purposes.

$${h}_{t} ( t - {t}_{k} ) = {\sum }_{l = 0}^{r} {α}_{l} {P}_{l} ( t - {t}_{k} ) \qquad ( 8 )$$

where tₖ are the times at which the series of events k occur.

FIG. 10B shows the specific values of the alpha coefficients used to represent the specific 1D temporal kernel hₜ(T) illustrated and expressed as truncated sum over five basis functions.

FIG. 10C illustrates a computation of a convolution operation when a kernel is represented as an expansion over basis functions, according to an embodiment of the present disclosure. In particular, FIG. 10C illustrates how the convolution operation in general may be computed when a kernel (here temporal) is represented as the expansion over basis functions. Here the orthogonal Legendre polynomials is used to represent the kernel as the expansion over basis function for illustration. The convolution of the kernel hₜ(τ) with an input I(t), noted as hₜ(τ)*I(t), may be computed as the weighted sum of the convolutions of the input I(t) with each basis function separately, according to an embodiment of the present disclosure. Further, representing input events as delta functions results in a kernel convolution with an input event to simply be given by the kernel centered (or started) at the specific time and location of the input event, according to an embodiment of the present disclosure. Thus, it is given by the finite sum of the coefficients alpha multiplying each of the basis functions centered at the time and location of the event, according to an embodiment of the present disclosure.

As shown in FIG. 10C, 1D kernel convolution with an input I(t) may be computed as the truncated weighted sum of five convolutions of the basis functions with the input I(t). According to an embodiment, provided a set of basis functions, the convolution of each of the basis function with the input I(t) can be computed in parallel, then each basis function is weighted by their respective kernel coefficients aₗ, l=0, 1, 2, 3, 4 then summed together to provide for the value of the convolution of the kernel with the input. This representation of the kernel as the sum of basis functions, such as orthogonal polynomials, enables any shape of the kernel to be represented efficiently. This means that any temporal dynamics can be represented in a compact form, which makes the chip implementation practical.

The network layer as shown in FIG. 8 has temporal dynamics represented by the temporal kernels. To represent the dynamics, say in a SNN, the conventional way is by using a set of differential equations describing the temporal dynamics for each synapse. Hence, say, considering 10 different synapses, each with its own dynamics described by say 3 differential equations, then each neuron must be represented by say, 10×3=30, different synaptic differential equations, with their own set of parameters. At scale, this leads to SNN chips with very few neurons, in the thousands and not in the millions. Thus, SSNs require a large number of differential equations to solve. On the other hand, the disclosed mechanism is much more practical and stable in learning to tune the parameters. Accordingly, when the inputs are events with each event represented by a delta function, the convolution of a kernel with the input yields the kernel localized at the event (shifted kernel). There are no more tens of differential equations to solve at every timestep per neuron. The disclosed solution is found simply by shifting kernels to the location of the events, and summing them up to found the neuron's potential resulting from the input events. Therefore, in the above example, 30 synaptic differential equations to solve step by step are replaced by say, 5 kernel coefficients for each of the 10 different synapse dynamics. Thus, 50 kernel coefficients that simply multiply one of five different basis functions, and which are then summed. This solution is valid not until the next time step, but until a new event arrives at the input, at which point, the solution is updated by adding this new contribution. These operations are much simpler to perform than having to integrate 30 differential equations, many of them stiff at every single time step.

Furthermore, the kernel represented as basis functions enables to perform computation and training continuously. The outputs, being events, are already discretized with the only specification left is the desired precision on the timestamps of each event for implementation during inference. Nevertheless, given that the kernel representation may be kept continuous during training, or projected back to a continuous representation after training, there is no need for retraining even if the discretization (binning) is changed to a different one for either changes in spatial resolution or in temporal sampling rate. Only simple computations are needed to adapt to new discretization in the data, no retraining of the network is needed, which is a substantial advantage to have this adaptability. Thus, the current mechanism is independent of any discretization.

According to an embodiment, a dimension of the basis function may be 1D, 2D, 3D or even higher multidimensional. For example, the spatial kernel 1D expanded over basis functions, such as orthogonal polynomials, is given by the equation (5) above. Representing kernels by a set of coefficients over a set of basis functions, such as orthogonal polynomials, has the following advantages:
It provides efficient parametrization (small number of parameters) of a kernel function, which may be arbitrary. That is, the kernel is adaptive to represent or process most data.
It provides a representation of a kernel that is independent of the binning because the basis functions are continuous and independent of the binning used, or in case of discrete basis, a new set of coefficients may be calculated from the old binning basis to the new binning basis, and, thus, new coefficients may be expressed in terms of the old.
Because the kernel representation is independent of the binning(s), changes in input data resolution (binning) in space and time do not necessitate to retrain the neural network.
It provides a rich representation, such that the adapted kernel may essentially represent directly the solution(s), sufficiently precisely, of most partial and ordinary differential equations using algebraic equations without having to solve any such differential equations.

Reference is made to FIG. 8 which illustrates schematically a neural network 800 comprising a plurality of layers. As seen in FIG. 8, the neural network 800 may comprise layer 1, layer 2, . . . layer N. Each layer of the plurality of layers may further comprise a plurality of neurons 810 configured to receive data, i.e., event-based data or spike-based data. That is, each of the plurality of neurons 810 may be configured to receive a corresponding portion of the event-based data. In some embodiments, the plurality of neurons 810 at the layer 1 may be configured to receive a corresponding portion of the event-based data from the event-based sensor that generates the event-based data. In some embodiments, the plurality of neurons 810 at the layer 2 may be configured to receive a corresponding portion of the event-based data in the form of neuron outputs associated with the plurality of neurons of the previous layer, i.e., layer 1 in the present example.

In some embodiments, as seen in FIG. 8, events 820 (alternatively referred as plurality of events 820) may be received at the plurality of neurons 810. As seen in FIG. 8, the events 820 may be received over one or more connections 830 associated with the respective neurons 810. That is, each neuron 810 may be associated with one or more connections 830 over which the events 820 may be received. It is appreciated that one or more details may be explained with respect to one neuron of the neural network 800, however, similar details may be analogously applicable to other neurons of the neural network as well.

Referring to a particular neuron 810a in the layer 1, events 820a may be received at the neuron 810a over the corresponding connection 830a. In some embodiments, the events 820a may be associated with an event-based sensor. Further, the corresponding connection 830a may be associated with kernels 840a. In some embodiments, the kernels 840a may include a first kernel and a second kernel, as detailed previously. In some embodiments, the first kernel may be a positive kernel and the second kernel may be a negative kernel. The neuron 810a may be associated with a potential which is determined by processing the events 820a being received over the connection 830a, as will be described in detail further below. In some embodiments, the potential associated with the neuron 810a is not a constant potential or a fixed potential, rather, the potential at the neuron 810a may be a variable potential that depends on the events 820a arriving at the neuron 810a, in particular, based on type of events, timing characteristics of the events, spatial characteristics of the events, etc.

In some embodiments, the neuron 810a may further be linked to another neuron 810b over the corresponding connection 830ab. The neuron 810b may be considered as a postsynaptic neuron with respect to the connection 830ab. The neuron 810b may be configured to receive events 820b from the neuron 810a. Further, similar to the connection 830a, the connection 830ab may be associated with the corresponding kernels 840b. In some embodiments, the corresponding kernels 840b may include a first kernel and a second kernel. Based on processing of the events 820b being received over the connection 830ab, the potential at neuron 810b may be determined, as will be described in detail further below.

Further, as depicted in FIG. 8, the neuron 810b may additionally be linked to another neuron in the layer 1, say, neuron 810c, over the corresponding connection 830cb. The corresponding connection 830cb may also be associated with the corresponding kernels 840c. At the neuron 810b, the potential may be determined based on processing of events 820c received at the neuron 810b over connection 830cb, as well as, the processing of the events 820b being received over the connection 830ab.

In an analogous manner, potential at each of the neurons 810 within the neural network 800 may be calculated based on the corresponding events 820 being received and based on the kernels at the corresponding connections of the neurons 810. As depicted in FIG. 8, one or more of the neurons 810 may be connected to a previous layer via a single connection, and one or more of the neurons 810 may be connected to a previous layer via multiple connections.

It is appreciated that for sake of brevity, one or more details of the present disclosure may be provided with reference to a random neuron (referred to as 810), and the associated events (referred to as 820) and connections (referred to as 830), however, analogous details would be equally applicable to other neurons within the neural network 800.

In some embodiments, a neuron 810 of the multiple neurons within the neural network 800 may be configured to receive an event from the plurality of events 820. In some embodiments, the plurality of events 820 may be received at different time instances. In one non-limiting example, a first event of the plurality of events may be received at time instance t₁, a second event of the plurality of events may be received at time instance t₂, a third event of the plurality of events may be received at time instance t₃, and the like.

In some embodiments, the neuron 810 may be associated with one or more connections, and a corresponding connection of the one or more connections may be determined, the corresponding connection being a connection over which the plurality of events 820 may be received at the neuron. As described above, the corresponding connection may be associated with a kernel 840. The potential of the neuron 810 may be determined based on processing of the kernel 840. The processing of the kernel 840 may include offsetting the kernel in one of a spatial dimension, a temporal dimension, or a spatiotemporal dimension, and further, determining the potential associated with the neuron 810 based on processing of the offset kernel. In some embodiments, processing of the offset kernels may comprise summing of the offset kernels with one or more other kernels in order to determine the potential at the neuron 810, as will be described in detail further below.

In some embodiments, the corresponding connection may be associated with kernel 840, which may comprise a first kernel and second kernel. As also described above, the event being received at the neuron 810 may belong to a first category or a second category. Based on the category of the event being received at the neuron 810, one of the first kernel or second kernel may be selected. That is, one of the first kernel or the second kernel associated with the corresponding connection over which the event is received may be selected, based on whether the received event belongs to the first category or the second category.

In some embodiments, the first category may be a positive category and the second category may be a negative category. Accordingly, when the received event belongs to the first category, the first kernel may be selected, which may be a positive kernel, and further, when the received event belongs to the second category, the second kernel may be selected, which may be a negative kernel. The selected kernel may be offset in one of a spatial dimension, a temporal dimension, or a spatiotemporal dimension, and further, the potential associated with the neuron 810 may be determined based on processing of the offset kernel.

In some embodiments, offsetting the selected kernel comprises shifting the selected kernel in one of a spatial dimension, a temporal dimension, or a spatiotemporal dimension. In some embodiments, offsetting the selected kernel comprises transforming the selected kernel based on timing information associated with the event and the selected kernel.

In some embodiments, the received event may be associated with one or more of spatial data, temporal data, and spatiotemporal data. In some embodiments, the neural network comprises one of spatial kernel(s), temporal kernel(s), and spatiotemporal kernel(s). When the received event is associated with spatial data, the kernel 840 may be a spatial kernel. Further, when the received event is associated with temporal data, the kernel 840 may be a temporal kernel. Furthermore, when the received event is associated with spatiotemporal data, the kernel 840 may be a spatiotemporal kernel.

In some embodiments, when the network comprises spatial kernel, the spatial kernel may be offset in a spatial dimension in order to determine the potential of the neuron 810. Further, when the network comprises temporal kernel, the temporal kernel may be offset in a temporal dimension in order to determine the potential of the neuron 810. Further, when the network comprises spatiotemporal kernel, the spatiotemporal kernel may be offset in a spatiotemporal dimension in order to determine the potential of the neuron 810.

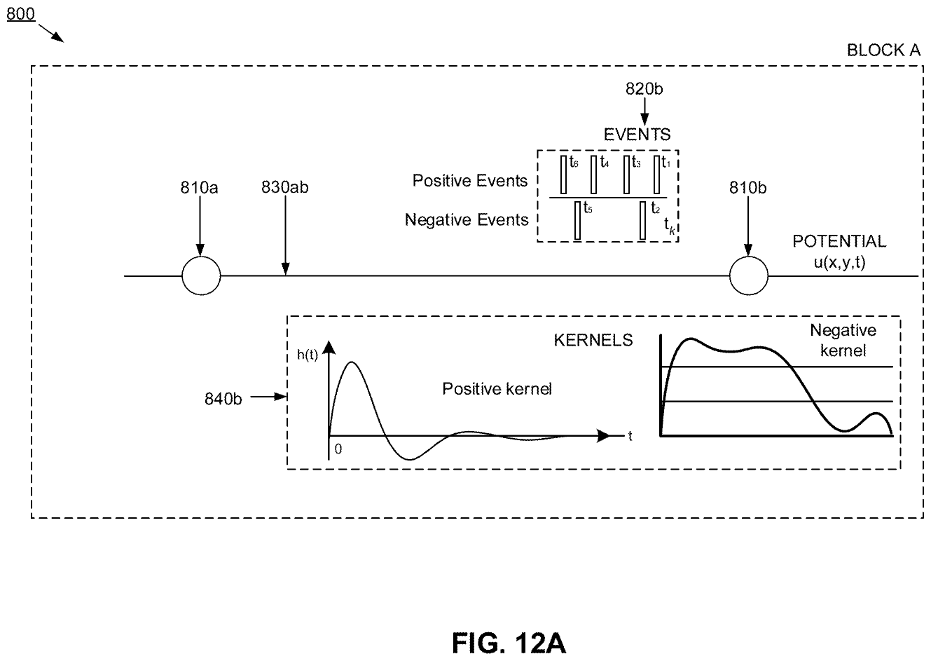

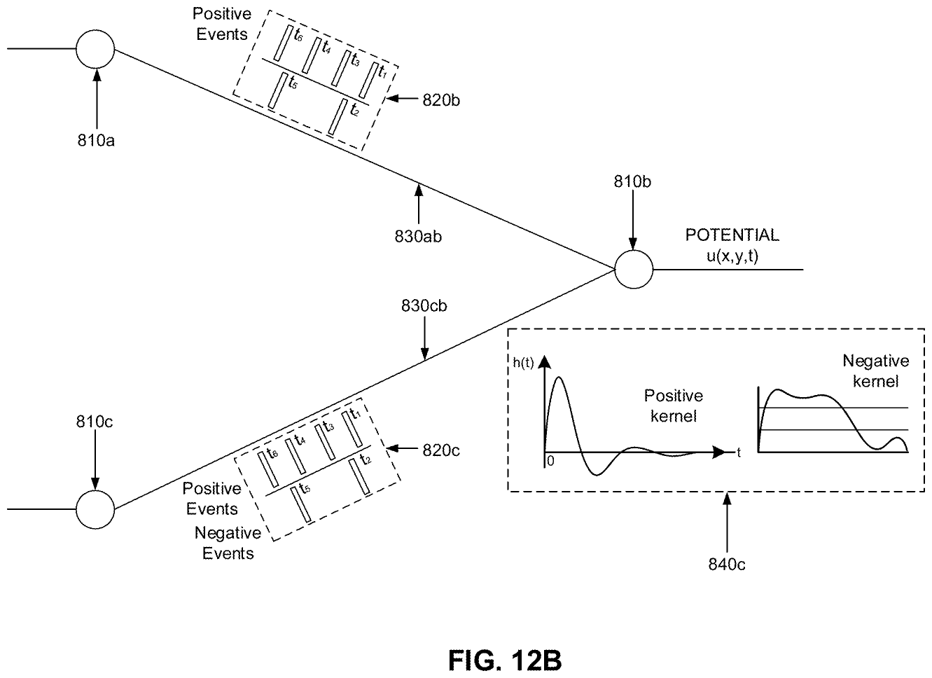

FIG. 12A-12B illustrate a close-up view of block A in FIG. 8 in order to depict neurons and the associated connections and the flow of events in the network. FIG. 12A-12B illustrates that each event type, positive or negative event, may be associated with a different temporal kernel respectively. For example, a positive kernel and a negative kernel, where positive and negative relate to the event type, not to the values of the kernel, which in both cases may take on positive and negative values, in accordance with an embodiment of the present disclosure. In the present disclosure, the positive, negative kernel is also referred to as the first, second kernel, respectively.

Referring to FIG. 12A, a close-up view of the block A of FIG. 8 is illustrated in order to depict neurons 810a and 810b and the connection 830ab associated there-with. It is appreciated that one or more details of the present disclosure may be provided with reference to neurons 810a and 810b, and the associated connections and kernels, however, analogous details would be equally applicable to other neurons within the neural network 800.

As seen in FIG. 12A, the neuron 810b is configured to receive the events 820b over the connection 830ab. The events 820b may comprise multiple events as depicted, in that, the multiple events 820b may be received sequentially at various time instances. For instance, over a time period, a first event may be received at time instance t₁, a second event may be received at time instance t₂, and so on for the third event, the fourth event, the fifth event, the sixth event, and any other subsequent events. Further, the multiple events may comprise positive events as well as negative events, for instance, the first event at time instance t₁ and the third event at time instance t₃ may be positive events while the second event at time instance t₂ and fifth event at time instance t₅ may be negative events. Similarly, the fourth event at time instance t₄ and the sixth event at time instance t₆ may be positive events. It is appreciated that the polarities of the events depicted in FIG. 12A are non-limiting examples, and in other examples, the multiple events may each have one of the positive or negative polarity.

Further, the connection 830ab may be associated with kernels 840b. In some embodiments, the kernels 840b may comprise a positive kernel h₁(t−tₖ) and a negative kernel h₂(t−tₖ), as depicted. In some embodiments, the kernels 840b may comprise a single kernel which may be multiplied by a positive polarity value to determine the positive kernel and a negative polarity value to determine the negative kernel, as also explained with reference to FIG. 5A. In some embodiments, the kernels 840b may comprise a single kernel which may be multiplied by a positive weighted function to determine the positive kernel and a negative weighted function to determine the negative kernel, as also explained with reference to FIG. 5B. It is appreciated that although the kernels may be depicted in the 1D form, the kernels may comprise multiple dimensions such as 2D, 3D, 4D, and the like without departing from the scope of the invention.

In some embodiments, the potential at the neuron 810b over a period of time may be determined based on processing of the kernels 840b being received at the neuron 810b over the connection 830ab during the period of time. For instance, the potential at the neuron 810b may be determined based on the equation (9):

$$u ( x , y , t ) = {\sum }_{k} h ( x - {p}_{k} , y - {q}_{k} , t - {t}_{k} ) \qquad ( 9 )$$

where h(⋅) is the spatiotemporal kernel used to determine the potential u(x,y,t) of each of the postsynaptic neurons, each at position (x,y) in the neural network at time t, (pₖ,qₖ) indicate the spatial location of the single presynaptic neuron that generated the network's kth event at time tₖ within the presynaptic layer within the neural network using some coordinate system, (x,y) indicates the spatial location of all the postsynaptic neurons that the presynaptic neuron projects to within the network in the same coordinate system.

In some embodiments, with reference to spatial kernels, the offsetting of the kernel may include centering a value of a spatial kernel hₓ(x) around the position of the presynaptic neuron, pₖ. In some embodiments, with reference to spatial kernels, the offsetting of the kernel may include shifting the kernel by the value of pₖ, to get hₓ(x−pₖ). In some embodiments, with reference to temporal kernels, offsetting of the kernel may include centering the kernel hₜ(t) around the time of the event, to get hₜ(t −tₖ).

In some embodiments, the spatiotemporal kernel may be separable into a spatial kernel hₓ and a temporal kernel hₜ. In such embodiments, the potential at the postsynaptic neurons may be determined from the equation (10):

$$u ( x , y , t ) = {\sum }_{k} {h}_{x} ( x - {p}_{k} , y - {q}_{k} ) {h}_{t} ( t - {t}_{k} ) \qquad ( 10 )$$

In some embodiments, the spatial kernel may be further separable into hₓ and h_{y}, and the potential at the postsynaptic neurons may be determined from the equation (11):

$$u ( x , y , t ) = {\sum }_{k} {h}_{x} ( x - {p}_{k} ) {h}_{y} ( y - {q}_{k} ) {h}_{t} ( t - {t}_{k} ) \qquad ( 11 )$$

In some embodiments, the data and network is only spatial, then the potential at the postsynaptic neurons may be determined from the equation (12):

$$u ( x , y ) = {\sum }_{k} {h}_{x} ( x - {p}_{k} , y - {q}_{k} ) \qquad ( 12 )$$

In some embodiments, the data and network is only temporal, then the potential at the postsynaptic neurons may be determined from the equation (13):

$$u ( t ) = {\sum }_{k} {h}_{t} ( t - {t}_{k} ) \qquad ( 13 )$$

In some embodiments, polarity of the events may additionally be considered to determine the potential, and the equation for the potential of neurons may be written as shown by equation (14):

$$u ( x , y , t ) = {\sum }_{k} h ( x - {p}_{k} , y - {q}_{k ,} t - {t}_{k} , {P}_{k} ) \qquad ( 14 )$$

where Pₖ is the polarity of the kth event and h(⋅) is a multidimensional kernel, which includes a dimension for the polarization of the events.

As described above, the first kernel may be a positive kernel and the second kernel may be a negative kernel. In such a scenario, the potential of neurons may be determined based on the equation (15):

$$u ( x , y , t ) = {\sum }_{k} {P}_{k}^{+} {h}^{+} ( x - {p}_{k} , y - {q}_{k} , t - {t}_{k} ) + {P}_{k}^{-} {h}^{-} ( x - {p}_{k} , y - {q}_{k} , t - {t}_{k} ) \qquad ( 15 )$$

where h⁺ is the positive kernel used for positive events

$${P}_{k}^{+} ,$$

and similarly, h⁻ is the negative kernel used for negative events

$${P}_{k}^{-} ,$$

where

$${P}_{k}^{+} = 1 , {P}_{k}^{-} = 0 ,$$

when the event is positive, and

$${P}_{k}^{+} = 0 , {P}_{k}^{-} = 1 ,$$

when the event is negative.

In some embodiments, as described above with reference to FIG. 5A, the first and second kernels, say, positive and negative kernels, may be associated with a common kernel. In such a scenario, the potential of neurons may be determined based on the equation (16):

$$u ( x , y , t ) = {\sum }_{k} {P}_{k} h ( x - {p}_{k} , y - {q}_{k} , t - {t}_{k} ) \qquad ( 16 )$$

where Pₖ=+1, for a positive event, and Pₖ=−1, for a negative event.

In some embodiments, as described above with reference to FIG. 5B, the first and second kernels, say, positive and negative kernels, may be associated with a common kernel with positive and negative weighted functions. In such a scenario, the potential of neurons may be determined based on the equation (17):

$$u ( x , y , t ) = {\sum }_{k} ρ ( {P}_{k} ) h ( x - {p}_{k} , y - {q}_{k} , t - {t}_{k} ) \qquad ( 17 )$$

where ρ(Pₖ) is a function of the polarity of the event, which may also be written as shown by equation (18):

$$ρ ( {P}_{k} ) = {W}^{+} {P}_{k}^{+} + {W}^{-} {P}_{k}^{-} \qquad ( 18 )$$

where W⁺ and W⁻ are weighting factor, where

$${P}_{k}^{+} = 1 , {P}_{k}^{-} = 0 ,$$

when the event is positive, and

$${P}_{k}^{+} = 0 , {P}_{k}^{-} = 1 ,$$

when the event is negative.

The computation method described in this document enables rapid processing with a considerably reduced number of parameters. When dealing with time series data, a significant challenge arises in evaluating the associated kernel at a large number of points along the time axis, often numbering in the tens of thousands or even hundreds of thousands of points. For instance, speech processing sampled at 16,000 Hz serves as an example. The conventional approach of assigning one weight to each time bin results in a high number of parameters to be trained for each neuron. Furthermore, the cost of representing the kernel for temporal convolution increases substantially. This becomes particularly problematic in neural networks comprising a large number of neurons. The present disclosure addresses these limitations by introducing a lightweight network with fewer parameters, capable of processing event-based time-series data with reduced latency and computational requirements, thereby overcoming the drawbacks of conventional methods.

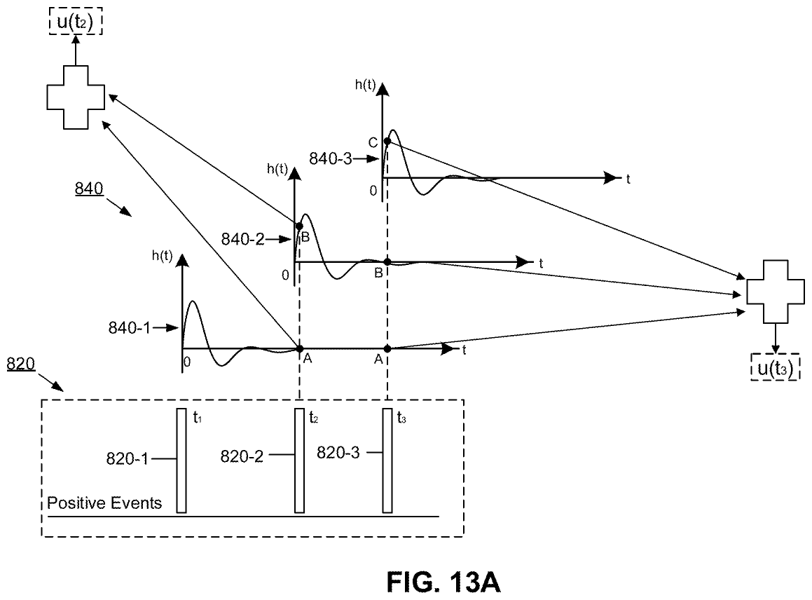

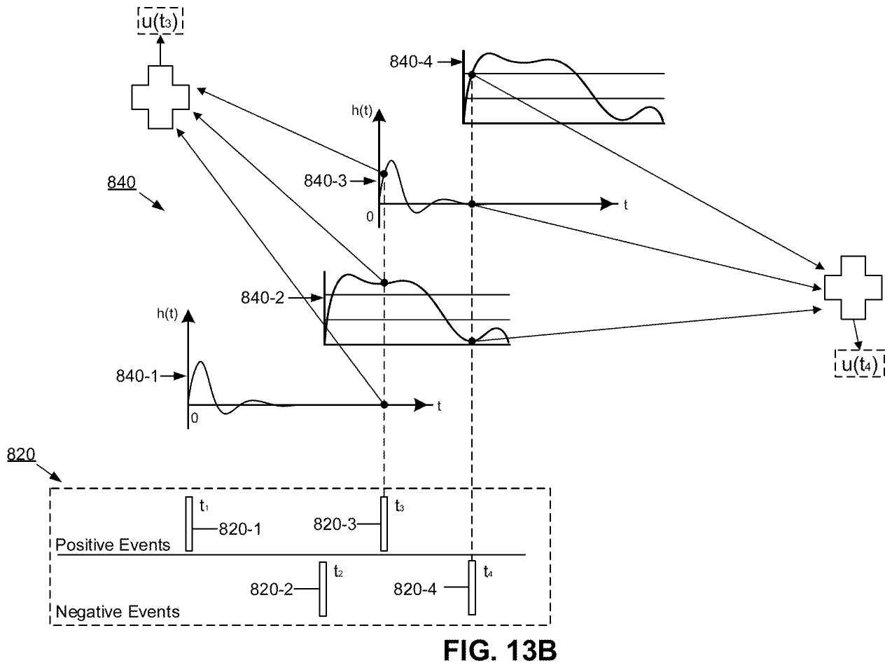

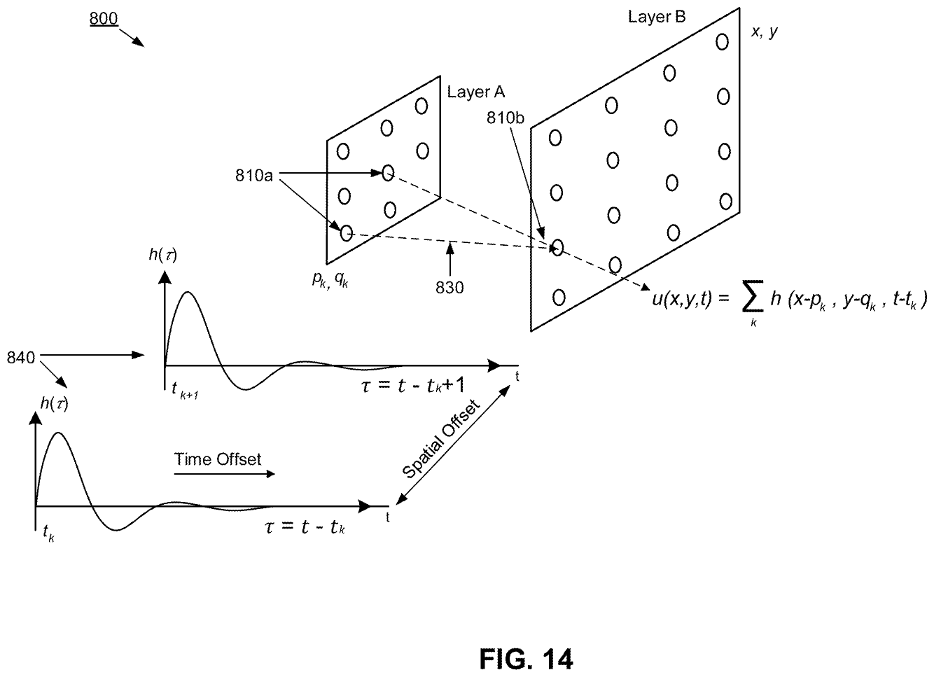

In some embodiments, processing of the kernels 840b comprises offsetting of the kernels in one of a spatial, a temporal, or a spatiotemporal dimension (as described with reference to FIG. 13-14), and further, summing the offset kernels to determine the potential. In other words, the neuron 810b may be configured to receive, over a period of time, an initial event at an initial time instance (for example, first event at time instance t₁) and one or more subsequent events at subsequent time instances (for example, second event at time instance t₂, third event at time instance t₃, and so on). The kernels corresponding to the one or more subsequent events may then be offset with respect to the kernel corresponding to the initial event. The kernels corresponding to the one or more subsequent events may then be summed with the kernel corresponding to the initial event, thereby determining the potential at the neuron 810b over the period of time.

As described above, potential at the neuron may be determined when the events are received at the neuron. As potential is determined only when new events are received, power efficiency of the neural network processing the event-based data is increased. This is because neuron potential is re-evaluated only upon arrival of events, and in between processing events, the system may shutdown or reduce power significantly to the neurons. In contrast, known methods that use time steps where every single neuron must be updated and their potential evaluated to verify whether the potential has reached threshold at every timestep and for every neuron. Moreover, since both types of kernels, i.e., positive and negative kernels, may be available for processing based on the polarity of the received events, a much faster processing is achieved.

In the illustrated embodiments, the events 820b being received over the period of time may comprise events of both a first and a second category, i.e., both positive and negative events. Accordingly, the potential at the neuron 810b over the period of time may be determined based on summation of the kernels 840b corresponding to the received events 820b. i.e., first kernels (such as, positive kernels) for events of first category and second kernels (such as, negative kernels) for events of second category. In some embodiments, the events 820b being received over the period of time may comprise events of a single category, such as, events from the first category (such as, positive events) or events from the second category (such as, negative events). Accordingly, the potential at the neuron 810b over the period of time may be determined based on summation of a single type of kernels 840b corresponding to the received events 820b. i.e., first kernels (such as, positive kernels) in case only events of first category are received and second kernels (such as, negative kernels) in case only events of second category are received.

In some embodiments, referring to FIG. 12B, the neuron 810b may additionally be configured to receive events 820c from neuron 810c over connection 820cb, in addition to receiving events from the neuron 810a. In some embodiments, the events 820c may comprise events from the first category as well as events from the second category. Over the period of time, the kernels 840b associated with the connection 820ab and the kernels 840c associated with the connection 820cb may be offset with respect to each other, and further, may be summed in order to determine the potential at the neuron 810b over the period of time. For instance, considering the events to be associated with temporal data, the potential u at the neuron 810b may be determined based on the equation (19):

$$u ( x , y , t ) = {\sum }_{k} {P}_{k}^{+} {h}^{+} ( x - {p}_{k} , y - {q}_{k} , t - {t}_{k} ) + {P}_{k}^{-} {h}^{-} ( x - {p}_{k} , y - {q}_{k} , t - {t}_{k} ) \qquad ( 19 )$$

presented above. Referring to FIG. 13A, a schematic diagram of kernels 840 associated with a connection of a neuron is illustrated to describe potential calculation based on offsetting of the kernels. in time, in accordance with an embodiment of the present disclosure. In some embodiments, the kernels 840 may refer to kernels 840a and/or 840b associated with connection 820ab and/or connection 820cb. The events 820 (for instance, corresponding to events 820a and/or 820b) may be received at a neuron 810 (for instance, neuron 810b). In the illustrated embodiment, the events 820 may be events of the first category, for instance, positive events.

At time instance t₁, a first event 820-1 may be received at the neuron 810 and the associated kernel 840-1 may be selected to determine the potential of the neuron 810 at time instance t₁. Further, at time instance t₂, a second event 820-2 may be received at the neuron 810 and the associated kernel 840-2 may be selected to determine the potential of the neuron 810 at time instance t₂. However, at time instance t₂, the kernel 840-1 is also taken into consideration, and the potential at time instance t₂ is determined based on both the kernels 840-1 and 840-2. In particular, at time instance t₂, the potential u(t₂) is determined based on summation of the kernel 840-1 and 840-2 at time instance t₂, as depicted by points A and B respectively that coincide at time instance t₂. Further, at time instance t₃, a third event 820-3 may be received at the neuron 810 and the associated kernel 840-3 may be selected to determine the potential of the neuron 810 at time instance t₃. At time instance t₃, the kernel 840-1 and kernel 840-2 is also taken into consideration, and the potential at time instance t₃ is determined based on the kernels 840-1, 840-2, and 840-3. In particular, at time instance t₃, the potential u(t₃ is determined based on summation of the kernel 840-1, 840-2, and 840-3 at time instance t₃, as depicted by points A, B, and C respectively that coincide at time instance t₃. In some embodiments, the potential may be determined based on the equation (20):

$$u ( t ) = {\sum }_{k} {h}_{t} ( t - {t}_{k} )$$

In some embodiments, the kernels 840 may be offset in the temporal dimension based on the respective time instances when the events 820 are received at the neuron 810. In the embodiment depicted in FIG. 13A, the kernels 840-1, 840-2, and 840-3 may be offset in the temporal dimension. In some embodiments, an offset value associated with each of the kernels 840-1, 840-2, and 840-3 may be determined based on the time instance when the associated events are received at the neuron 810, the offset value defining an amount of offset of the respective kernels 840-1, 840-2, and 840-3. As a result of offsetting of the kernels, an efficient computation of potential is achieved. When events characterized by the time of arrival and position are received at a layer, the contribution to all postsynaptic neurons can be easily computed at once if each connection has the same kernel. The computationally intensive conventional process of receiving input, using the weights for the connections, and combining of weights is thus no longer required. This leads to a faster and efficient computation for the neurons within the neural network. Moreover, as also described above, the computation method as described herein allows fast processing with significantly lower number of parameters which overcomes the problem of evaluating kernels at large number of points to process time series data using conventional techniques. In other words, the conventional representation of using 1 weight for each timebin, means that there are a lot of parameters to train for each neuron, The present disclosure provides a network with less parameters that processes event-based time-series data with reduced latency and less computations.

In some embodiments, time intervals between the time instances when the associated events are received at the neuron 810 may be determined. For instance, in the embodiment depicted in FIG. 13A, event 820-1 may be considered as an initial event and events 820-2 and 820-3 may be considered as subsequent events. The time intervals between an initial time instance when the initial event (event 820-1) is received at the neuron and the subsequent time instances when the subsequent events (events 820-2 and 820-3) are received at the neuron 810 may be determined, and further, the associated kernels (840-1, 840-2, and 840-3) may be offset with respect to each other based on the time intervals. Further, the offset kernels may be summed in order to determine the potential (u(t₁), u(t₂), u(t₃), and so on) over the period of time when the events 820 are received. In some embodiments, time intervals between the initial time instance when the last event is received at the neuron and preceding time instances when one or more preceding events are received at the neuron may be determined, the time intervals defining a difference in time of arrival of the events at the neuron.

In some embodiments, the events 820 may be events of both the first category and the second category, for instance, both positive events and negative events. Referring to FIG. 13B, events 820-1 and 820-3 may be events of the first category (positive events) and events 820-2 and 820-4 may be events of the second category (negative events). Based on the respective time instances t₁, t₂, t₃, and t₄ of arrival of the events 820-1, 820-2, 820-3, and 820-4, the associated kernels 840-1, 840-2, 840-3, and 840-4 may be offset with respect to each other, and further, may be summed to determine the potential at neuron 810 over the period of time when the events 820 are received. In the illustrated embodiment, the kernels 840-1 and 840-3 may be kernels of a first type, such as positive kernels, while the kernels 840-2 and 840-4 may be kernels of a second type, such as negative kernels. As seen in FIG. 13B, potential u(t₃) at time instance t₃ may determined by summation of kernels 840-1, 840-2, and 840-3, as depicted by points A, B, and C. Further, potential u(t₄) at time instance t₄ may be determined by summation of kernels 840-2, 840-3, and 840-4, as depicted by points B, C, and D. It is appreciated that the details provided above with respect to FIG. 13A are equally applicable for FIG. 13B as well, and the details have not been repeated for sake of brevity. In the event-based processing described in this disclosure, the processing within a neuron commences exclusively when an event is detected at its input. The processing persists until the effects of the event are fully integrated into the neuron's computations, thereby influencing the timing of its subsequent event generation. During this event-driven processing, the neuron's potential undergoes re-evaluation upon the arrival of each event. In the intervals between processing events, the system may enter a shutdown state or substantially reduce power allocation to the neurons.

Reference is made to FIG. 14, which schematically illustrates potential calculation based on offsetting of the kernels in accordance with another embodiment of the present disclosure. The neural network 800 may comprise layer A and layer B, in that, a neuron 810b of the layer B may receive events from one or more neurons 810a of the layer A over the corresponding connections 830. The events may be associated with spatial data and/or temporal data, and thus, the kernels 840 associated with the corresponding connections 830 may be offset in the spatial dimension and/or the temporal dimension. A skilled person in the art would appreciate that when both spatial and temporal components are present, the data may be a spatiotemporal data and the offsetting of the associated kernels may be in the spatiotemporal dimensions.

As seen in FIG. 14, the neurons 810a of the layer A may be associated with coordinates pₖ, qₖ in that, pₖ and qₖ define a location of the respective neurons 810a within the layer A. Further, tₖ is associated with time of the corresponding events generated at layer A. Further, the neuron 810b may be associated with coordinates x, y, t, in that, x and y define a location of the neurons 810b within the layer B and t is associated with the time at which the neuron's potential in layer B is to be evaluated. As described above, the potential of the neuron 810b may be determined based on the time of arrival of the corresponding events as well as location of the neuron 810a of the previous layer, i.e., layer A. In other words, the associated kernels 840 may be offset in the spatial dimension based on the locations of the kernels 840a, 840b, i.e., based on the value of pₖ, qₖ, x and y. Further, the associated kernel may be offset in the temporal dimension based on the values of tₖ and t, as also described with reference to FIG. 13A-13B.

Further, the offset kernels, for instance h(τ), may be summed in order to determine the potential over the period of time when the events are received at the neuron 810b. FIG. 14 schematically depicts offsetting of the kernels h(τ) in the spatiotemporal dimension, i.e., in both spatial dimension as well as temporal dimension—as is evident from the equations τₖ₊₁=t−tₖ₊₁ for one kernel and τₖ=t−tₖ for another kernel. In some embodiments, over a certain time period T the kernels associated with the neuron may be evaluated at the different time intervals τₖ=t−tₖ from the events generated at tₖ and indexed over k, such that {h₁(τₖ)}=h₁(τ₁), h₁(τ₂), . . . , h₁(τ_{K}), where h₁(⋅) is the temporal kernel for a particular connection between two neurons, τₖ=t−tₖ, {h₁(τₖ)} is the set of shifted kernels generated by the events, and K is the number of events produced by the neuron over the time period.

In some embodiments, the offsetting of the corresponding kernels with respect to each other in the spatiotemporal dimension may be based on an offset value defining the extent of the offsetting of the kernels. In some embodiments, the offset value may be determined based on position of the corresponding neurons sending the events as well as the time instances when the events are received at the neuron. The determination of the potential of the neuron 810b may be based on the equation (21):

$$u ( x , y , t ) = {\sum }_{k} {P}_{k}^{+} {h}^{+} ( x - {p}_{k} , y - {q}_{k} , t - {t}_{k} ) + {P}_{k}^{-} {h}^{-} ( x - {p}_{k} , y - {q}_{k} , t - {t}_{k} ) \qquad ( 21 )$$

where h⁺ is the positive kernel used for positive events

$${P}_{k}^{+} ,$$

and similarly, h⁻ is the negative kernel used for negative events

$${P}_{k}^{-} ,$$

where

$${P}_{k}^{+} = 1 , {P}_{k}^{-} = 0 ,$$

when the event is positive, and

$${P}_{k}^{+} = 0 , {P}_{k}^{-} = 1 ,$$

when the event is negative.

As an example, considering two events being received at the neuron, with the first event having the corresponding kernel centered at (p₁,q₁,t₁) and the second event having the corresponding kernel centered at (p₂,q₂,t₂), then, assuming two positive events, the sum of kernels may provide the potential as shown by the equations (22) and (23) below:

$$u ( x , y , t ) = {P}_{1}^{+} {h}^{+} ( x - {p}_{1} , y - {q}_{1} , t - {t}_{1} ) + {P}_{2}^{+} {h}^{+} ( x - {p}_{2} , y - {q}_{2} , t - {t}_{2} ) \qquad ( 22 )$$

$$u ( x , y , t ) = {h}^{+} ( x - {p}_{1} , y - {q}_{1} , t - {t}_{1} ) + {h}^{+} ( x - {p}_{2} , y - {q}_{2} , t - {t}_{2} ) , \qquad ( 23 )$$

since

$${P}_{k}^{+} = 1$$

for a positive event.

As the kernels associated with the received events are summed by themselves, considering the neuron being provided in a layer with other neurons, an efficient manner of computing the responses of the neurons in the layer is achieved. The responses of the neurons in the layer can be efficiently computed at once. At each neuron of the layer, the contributions of the events to all the neurons are immediately computed. In case it is desired to view individual values of the neurons in the layer, a simple lookup is possible. The processor takes into account the time of arrival of events and position of previous neuron sending the events in order to generate the potential. That is, the events, characterized by arrival times, address of neurons, and polarity of events, are communicated within the neuron network. An efficient manner of summation and response calculation is achieved for all neurons in the layer at once.

The process of kernel offsetting enables a more efficient computation of potentials within the neural network. When events with temporal and spatial attributes reach a layer, the simultaneous calculation of contributions to all postsynaptic neurons becomes feasible. Consequently, the traditional computationally intensive steps of receiving input, applying connection weights, aggregating weights and solving a set of differential equations at each timestep are eliminated. This advancement significantly accelerates and streamlines the computation process for the neurons in the neural network, resulting in enhanced speed and efficiency.

In some embodiments, the polarity of the events, say Pₖ, may be considered to determine the potential at the neuron 810b. As described above, the polarity of the events may determine the kernels to be selected for processing, in that, positive events may lead to selection of positive kernels and negative events may lead to selection of negative events. The determination of the potential of the neuron 810b may also be based on the equation (15) above:

$$u ( x , y , t ) = {\sum }_{k} {P}_{k}^{+} {h}^{+} ( x - {p}_{k} , y - {q}_{k} , t - {t}_{k} ) + {P}_{k}^{-} {h}^{-} ( x - {p}_{k} , y - {q}_{k} , t - {t}_{k} ) \qquad ( 15 )$$

It is to be noted herein that the sum is over all the received events up to time t, such that tₖ≤t, and Pₖ is the polarity of the event at tₖ and location (pₖ,qₖ). The value of u(x,y,t) may thus be considered as the sum of kernel value h(⋅) at the time and position of each event taking into consideration the polarity of each event.

In some embodiments, the events may be associated with spatial data, and the corresponding kernels may be offset based on the position of the neurons in the previous layer, such as layer A, relative to the neuron's position in layer B. In some embodiments, the offsetting of the corresponding kernels with respect to each other may be based on an offset value defining the extent of the offsetting of the kernels. In some embodiments, the offset value may be determined based on position of the corresponding neurons sending the events, such as neurons 810a in the layer A and the neurons receiving the events in layer B. In some embodiments, the determination of the potential of the neuron 810b may be based on the equation on the same equation (15) above.

In some embodiments, the neuron 810b in layer B may be connected to the neuron 810a in the layer A, and may be configured to receive, at different time instances over the period of time, events of a same category (such as, only positive events or only negative events) or different categories (such as, both positive and negative events) from the neuron 810a. The events may be received at different time instances and the potential at the neuron 810b over the period of time may be determined based on the time instances of the events being received at the neuron 810b.

In some embodiments, the neuron 810b in layer B may be connected to more than one neuron 810a in the layer A over corresponding connections. The neuron 810b may be configured to receive, at different time instances over the period of time, events of a same category (such as, only positive events or only negative events) or different categories (such as, both positive and negative events) from the neuron 810a. The potential at the neuron 810b over the period of time may be determined based on the time instances of the events being received at the neuron 810b.

In some embodiments, the kernel may be extended to become dependent of the neuron's potential. The kernel may be separable with a spatial kernel, a temporal kernel, a polarity kernel and potential kernel. The polarity kernels may be selected based on the polarity of the received events, as presented above. The potential kernel may be selected based on a current value of the potential. The potential of the neuron may be described with the following equation (24):

$$u ( x , y , t ) = {\sum }_{k} h ( x - {p}_{k} , y - {q}_{k} , t - {t}_{k} , {P}_{k} , u ( x , y , t ) ) \qquad ( 24 )$$

where Pₖ is the polarity of the kth event and h(⋅) is a multidimensional kernel, which includes a dimension for the polarization of the events and a dimension for the potential value itself, defined in a recurrent fashion, moving forward in time. Separating the polarity and potential dependencies, the kernel may be expressed as equation (25):

$$u ( x , y , t ) = {h}_{u} ( u ) {\sum }_{k} {h}_{xt} ( x - {p}_{k} , y - {q}_{k} , t - {t}_{k} ) {h}_{P} ( {P}_{k} ) \qquad ( 25 )$$

where

$${h}_{P} ( {P}_{k} ) = ρ ( {P}_{k} ) = {W}^{+} {P}_{k}^{+} + {W}^{-} {P}_{k}^{-}$$

presented above, and the potential kernel hᵤ(u) may be any arbitrary function which depends on the potential u(⋅), and where the spatiotemporal kernel hₓₜ may be itself separable as presented above. The potential kernel hᵤ(u) renders the effect of a new input event dependent on the current state of the neuron, and therefore on the previous historical activity of the neuron. This potential equation may be understood as a forward mapping from variables to potential and not as a self-consistent equation to be solved for the potential u(⋅), since u(⋅) now appears on both sides of the equation.

In some embodiments, as described above, potential of the neuron at any time point u(t) is obtained by the summation of all the dynamical synaptic potentials present at that time, i.e., each individual contribution to the neuron potential coming from each synapse. The potential of the neuron may then be passed through a neuron output function ƒ(u(t)) to provide the neuron output potential v(t)≡ƒ(u(t)). In some embodiments, the neuron output function may be a nonlinear function, and may be different for each neuron.

In some embodiments, the output of the neuron may be computed based on the equation (26):

$$( {t}_{k} , {x}_{k} , {y}_{k} , {P}_{k} ) = θ ( f ( u ( x , y , t ) ) \qquad ( 26 )$$

where [symbol] (pₖ,qₖ,tₖ) represents the new event being generated at the neuron's location (pₖ,qₖ) and at time tₖ, ƒ(u) may be a nonlinear function and θ(v) may be a function, which generates an event at the time tₖ when v crosses a positive threshold v⁺ or negative threshold v⁻. In some embodiments, once the threshold is reached, in addition to reporting the time tₖ and the polarity, the value v may be reset to a reset value. In some embodiments, the reset value may be zero.

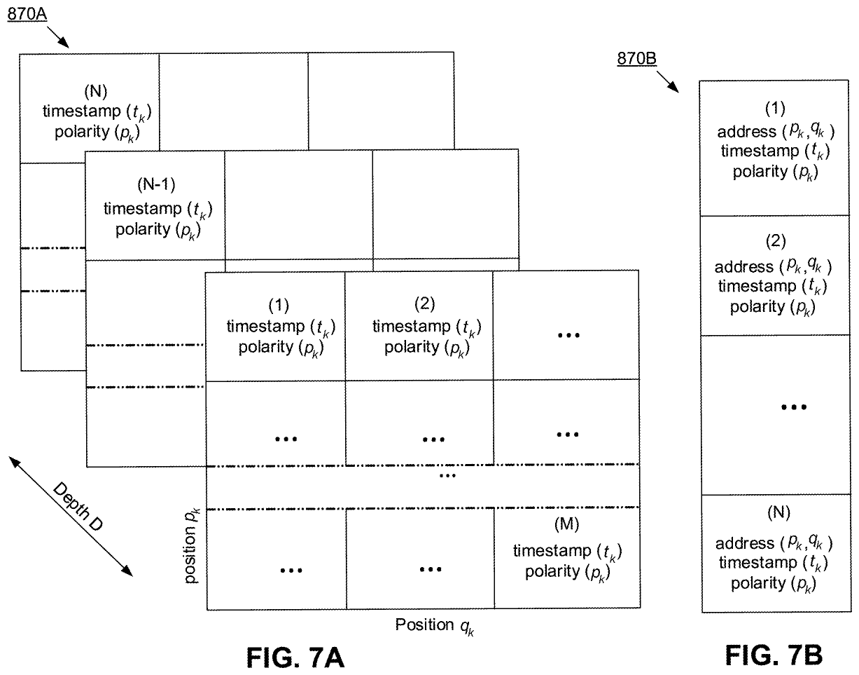

In some embodiments, each neuron within the neural network 800 may be associated with a memory buffer 870A, 870B, as depicted in FIG. 7A and FIG. 7B. In some embodiments, the memory buffer may be a 3D memory buffer 870A, as shown in FIG. 7A. In some embodiments, the memory buffer 870A may include information associated with events being received at the respective neurons. In some embodiments, each cell within the memory buffer 870A may comprise timestamp (tₖ) and the polarity (Pₖ) of the events arriving at the respective neurons. Further, the positions pₖ and qₖ may define coordinates of the presynaptic neuron, from a previous layer, that generated the events and that is being sent to the respective neurons. The positions pₖ and qₖ may be stored implicitly by the structure of the buffer itself as in FIG. 7A. In some embodiments, as multiple events may be coming from the same presynaptic neurons that are being received at the respective neurons, accordingly, the memory buffer 870A may comprise a depth D for the cells within the memory buffer 870A such that the required information for the received events may be retrieved from the relevant cell of the memory buffer 870A. In other words, in case there are more than one event per spatial bin, then the events may accumulate at the spatial location along the depth D.

By virtue of the buffer memory 870A, the communication between the neurons in the neural network may be based on events characterized by addresses of the neurons (pₖ, qₖ), presynaptic, that is, of a previous layer that generated the events, the time tₖ of the events, and the polarity Pₖ of the events. In some embodiments, the presynaptic neuron event address is encoded in the location within the memory buffer 870A, the timestamp tₖ of the event may be an analog value being communicated along with the polarity Pₖ of the event at the event address. Thus, accumulating the events in the memory buffer 870A enables accurate computation even in the scenario where an associated hardware falls behind real-time processing. In case events are not accumulated, the events may be lost, and precision of the computation may be affected.

In some embodiments, the memory buffer may be a 1D memory buffer 870B, as shown in FIG. 7B. In some embodiments, a list of all the events with their properties are stacked one after another, as shown in FIG. 7B. The memory buffer 870B may include information associated with the events being received at the respective neurons, i.e., the address of the event (pₖ,qₖ), the timestamp tₖ of the events, and the polarity Pₖ of the events. The positions pₖ and qₖ may be stored explicitly as shown in FIG. 7B.

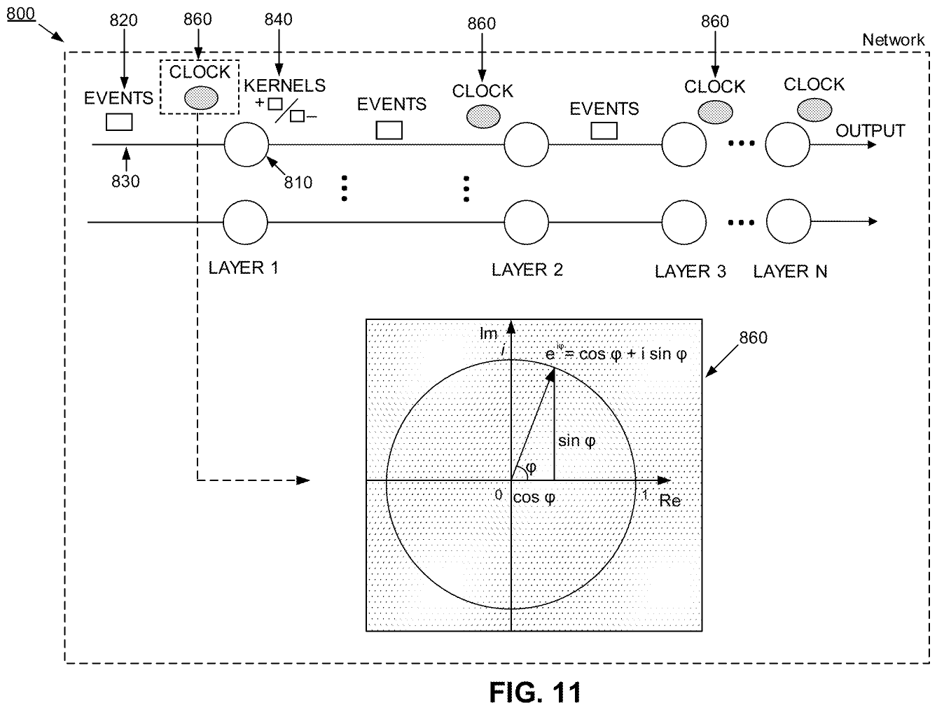

In some embodiments, each layer within the neural network 800 may be associated with a respective clock. In some embodiments, each neuron within the neural network 800 may be associated with a respective clock. FIG. 11 illustrates an example representation that clocks associated with layers or neurons within the neural network may run at different rates. The clock may be represented as a phasor, which is a vector rotating along the unit circle. The phasor rotating such that the angle phi is given by an angular frequency times the time, φ=ωt, with the period to rotate a full circle being the period over which the temporal kernel is defined, according to an embodiment of the present disclosure. The phasor representation is used such that the difference in timestamps between two events with such a clock that resets periodically is simply related to the difference in angles of their phasors.

According to an example embodiment depicted in FIG. 11, the neural network 800 may be associated with clocks 860 for each of the layers, i.e., layer 1, layer 2, and the like. The clock 860 may be referred to as an internal clock for the respective layers. As seen in FIG. 11, the clock 860 may be represented by a phasor, which is a vector rotating along the unit cercle. The angle φ may be defined based on speed of the associated layer, or in some embodiments, the respective neuron, and the time used in determining the kernel value. In some embodiments, the angle φ may be such that the clock may run faster for initial layers and slower for deep layers within the neural network 800. The clocks associated with layers or neurons within the neural network may run at different rates; the phasor rotates such that the angle phi is given by an angular frequency times the time, φ=ωt, with the period to rotate a full circle being the period over which the temporal kernel is defined, according to an embodiment of the present disclosure. The phasor representation is used such that the difference in timestamps between two events with such a clock that resets periodically is simply related to the difference in angles of their phasors.

In some embodiments, based on the clock 860, the number of bits to represent the overall period over which the kernel is non-zero may be specified; this defines a discretization of time, or timebin. In some embodiments, the period may define the time period over which convolution may be computed. As a result, the size of each timebin may be defined. In some embodiments, each of the respective layer, or in some embodiments, the respective neuron, may use a different period for the associated kernel and thus be associated with a different time discretization or timebin size for the same number of bits used to specify time. In some embodiments, the initial layers within the neural network may have shorter timebins and the deep layers within the neural network may have longer timebins.

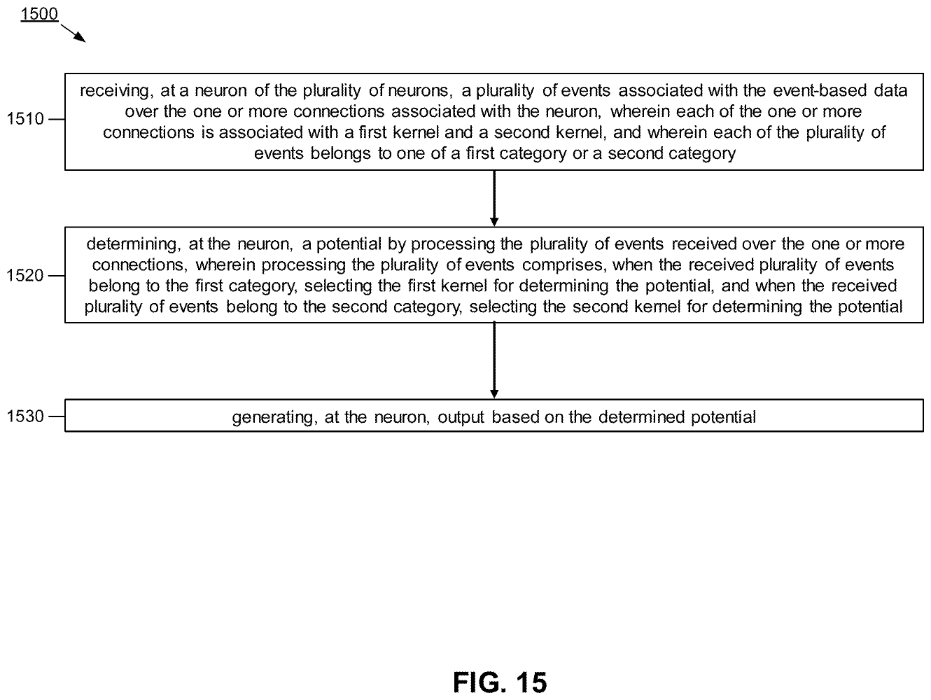

FIG. 15 illustrates a flow chart of a method 1500 for processing event-based data using a neural network, in accordance with an embodiment of the present disclosure. The method 1500 may be performed by the system as described with reference to any of FIGS. 1-2. As described above, the neural network may comprise a plurality of neurons and one or more connections associated with each of the plurality of neurons. In some embodiments, each of the plurality of neurons may be configured to receive a corresponding portion of the event-based data.

At step 1510, the method 1500 comprises receiving a plurality of events associated with the event-based data at a neuron of the plurality of neurons. The plurality of events may be received over the one or more connections associated with the neuron. In some embodiments, each of the one or more connections is associated with a first kernel and a second kernel, and wherein each of the plurality of events belongs to one of a first category or a second category. In some embodiments, the first kernel may be a positive kernel and the second kernel may be a negative kernel. In some embodiments, the events belonging to the first category may be positive events and the events belonging to the second category may be negative events.

At step 1520, the method 1500 comprises determining a potential at the neuron by processing the plurality of events received over the one or more connections. When the received plurality of events belongs to the first category, the method 1500 comprises selecting the first kernel for determining the potential. When the received plurality of events belongs to the second category, the method 1500 comprises selecting the second kernel for determining the potential.

At step 1530, the method 1500 comprises generating, at the neuron, output based on the determined potential.

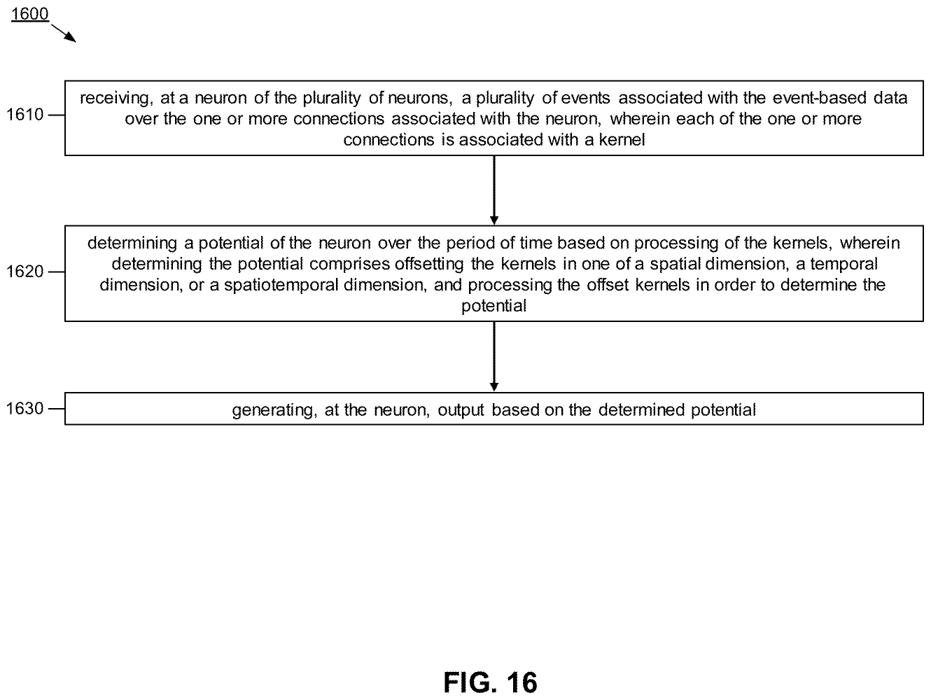

FIG. 16 illustrates a flow chart of a method 1600 for processing event-based data using a neural network, in accordance with an embodiment of the present disclosure. The method 1600 may be performed by the system as described with reference to any of FIGS. 1-2. As described above, the neural network may comprise a plurality of neurons and one or more connections associated with each of the plurality of neurons. In some embodiments, each of the plurality of neurons may be configured to receive a corresponding portion of the event-based data.

At step 1610, the method 1600 comprises receiving a plurality of events associated with the event-based data at a neuron of the plurality of neurons. The plurality of events may be received over the one or more connections associated with the neuron. In some embodiments, each of the one or more connections may be associated with a kernel.

At step 1620, the method 1600 comprises determining a potential of the neuron over the period of time based on processing of the kernels. In some embodiments, the potential of the neuron may be considered a dynamic potential that varied over the period of time. To determine the potential, the method 1600 comprises offsetting the kernels in one of a spatial dimension, a temporal dimension, or a spatiotemporal dimension, and further, processing the offset kernels in order to determine the potential.

At step 1630, the method 1600 comprises generating, at the neuron, output based on the determined potential.

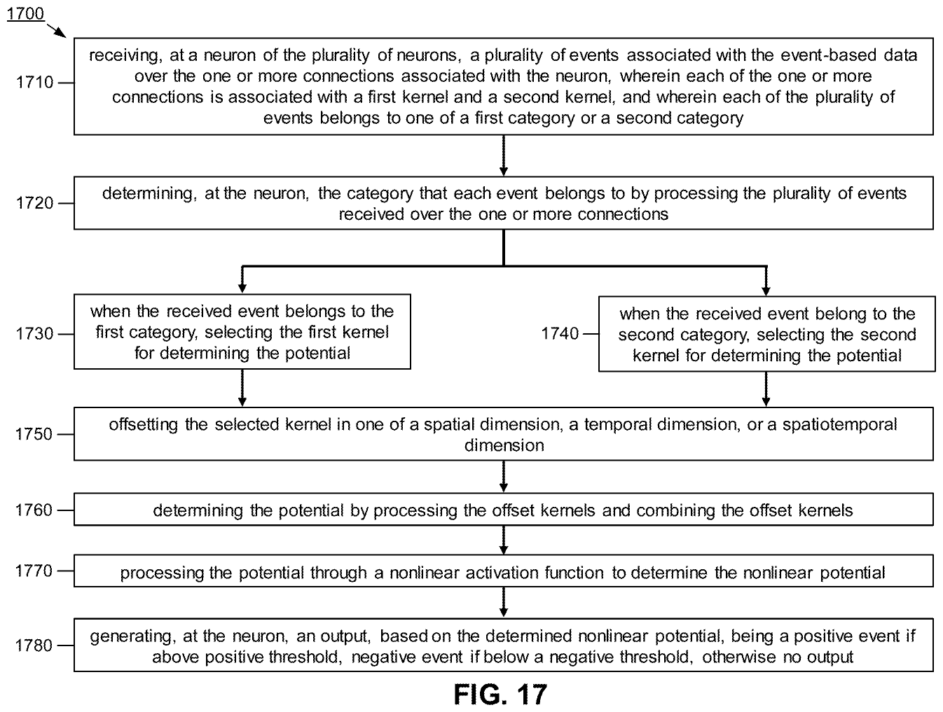

FIG. 17 illustrates a flow chart of a method 1700 for processing event-based data using a neural network, in accordance with another embodiment of the present disclosure. The method 1700 may be performed by the system as described with reference to any of FIGS. 1-2. At step 1710, the method 1700 comprises receiving a plurality of events associated with the event-based data at a neuron of the plurality of neurons. Each of the one or more connections is associated with a first kernel and a second kernel, and further, each of the plurality of events belongs to one of a first category or a second category.

At step 1720, the method 1700 comprises determining, at the neuron, a category that each event belongs to by processing the plurality of events received over the one or more connections. When the received plurality of events belongs to the first category, at step 1730, the method 1700 comprises selecting the first kernel for determining the potential. When the received plurality of events belongs to the second category, at step 1740, the method 1700 comprises selecting the second kernel for determining the potential.

At step 1750, the method 1700 comprises offsetting the selected kernels in one of a spatial dimension, a temporal dimension, or a spatiotemporal dimension. In some embodiments, when the event-based data relates to temporal data and the network comprises temporal kernels, the kernels may be offset in the temporal dimension, when the event-based data relates to spatial data and the network comprises spatial kernels, the kernels may be offset in the spatial dimension, when the event-based data relates to spatiotemporal data and the network comprises spatiotemporal kernels, the kernels may be offset in a spatiotemporal dimension.

At step 1760, the method 1700 comprises determining a potential at the neuron by processing the offset kernels and combining the offset kernels, over the period of time determined by the kernels. In some embodiments, the potential of the neuron may be considered a dynamic potential that varies over the period of time. In some embodiments, the processing of the offset kernels may comprise summation of the offset kernels in order to determine the potential over the period of time. In some embodiments relating to temporal data, summation of the offset kernels may include summation of kernels offset based on a time instance when the respective events were generated and the current time at the neuron. In some embodiments relating to spatial data, summation of the offset kernels may include summation of offset kernels based on the relative position of an earlier presynaptic neuron sending the events and the position of the postsynaptic neuron receiving the events. In some embodiments relating to spatiotemporal data, summation of the offset kernels may include summation of offset kernels based on a time instance when the respective events were generated and the current time at the neuron as well as the relative position of an earlier presynaptic neuron sending the events and the position of the neuron receiving the events.

At step 1770, the method 1700 comprises processing the determined potential at the neuron through a nonlinear activation function to determine the nonlinear potential. At step 1780, the method 1700 comprises generating, at the neuron, an output based on the determined nonlinear potential. The output generated may be a positive event if the determined nonlinear potential is above a positive threshold, or negative event if below a negative threshold, or with no output otherwise.

Although FIG. 17 depicts the output based on the determined nonlinear potential, in some embodiments, additional block of nonlinearity may be provided to generate further intermediate value(s) that is compared with the positive threshold value or negative threshold value, or using the determined potential directly instead of the determined nonlinear potential, as also described with reference to FIGS. 3-6.

While the above steps of FIGS. 15-17 are shown and described in a particular sequence, the steps may occur in variations to the sequence in accordance with various embodiments of the disclosure. Further, a detailed description related to the various steps of FIGS. 15-17 is already covered in the description related to FIGS. 1-14 and is omitted herein for the sake of brevity.

Skilled artisans will appreciate that although the details have been explained with respect to a neuron within the neural network, the same details are applicable for other neurons within the neural network, such as, the neural network as described with reference to FIG. 8. Thus, within the neural network, the potential of a neuron in any layer of the neural network may depend on which neurons in previous layers are active, and additionally, at what time instances are the neurons active. Accordingly, both space and time parameters are taken into consideration.

The present invention provides systems and methods to adaptively process time series data generated from event-based sensors based on spatiotemporal adaptive kernels, which may be expressed as polynomial expansions with intrinsic Lebesgue sampling. The present disclosure provides methods and systems for neural networks that allows spatiotemporal data processing in an efficient manner, with low memory as well as low power. That is, the present invention provides power efficient neural networks that more closely reproduces the dynamical characteristics of biological based implementations. The present invention further provides a memory efficient implementation, i.e., a light network with less parameters. The systems and methods as disclosed herein allow processing of event-based data with good accuracy in minimum time, reduced latency, less computations, and less parameters.

The systems and methods as disclosed herein are beneficial for applications such as object detection, object segmentation, object tracking, gesture recognition, facial identification, and depth estimation. Further, the systems and methods as disclosed herein take spike timing (event timing) into account and are not based on an assumption of information encoded in firing rate. Thus, the systems and methods as disclosed herein perform much closer to the biological brain efficiency and capability.

Further, since both types of kernels, i.e., positive and negative kernels, may be available for processing based on the polarity of the received events, a much faster processing is achieved and more abrupt changes of membrane voltage in time is achieved. The systems and methods as disclosed herein are more efficient since every neuron may have an excitatory or inhibitory effect, which can flip from one to another at any time, on the postsynaptic neuron, simply depending on the values of the kernels, which are arbitrary and adapted to the data. Compared to models of biological spiking neurons, the current neurons have the equivalent effect on a postsynaptic neuron as a small population of spiking neurons, e.g. a combination of separate excitatory and inhibitory spiking neurons to reproduce the effect provided by one neuron herein. Thus, the systems and methods disclosed herein, necessitates less neurons overall to induce similar dynamical effects in postsynaptic neurons, and are thus more efficient than simulating typical models of biological spiking neurons. Additionally, the necessity to solve for any number of differential equations is completely inexistent compared to such biological models. Moreover, as the kernels in the present disclosure are represented as an expansion over continuous basis functions, such as over orthogonal polynomials, the representation of the kernels provided herein is independent of binning, and further, an efficient parametrization of kernel function is provided which may be derived from input data. In addition, the computation of the potential of neurons becomes possible using algebraic equations.

Another advantage of event processing implementation as disclosed in the present disclosure is that power efficiency is achieved due to the reevaluation of neuron potential only when new information, i.e., new events, are received at the neuron. In other words, there is no need for the usage of time steps as the processing at a neuron only needs to be reevaluated whenever an event is present at the input of a neuron and the processing stops when the effects of the event have been taken into account in determining when the neuron will generate the next event. This is in contrast to known methods that use time steps where every single neuron must be updated and their potential evaluated to verify whether the potential has reached threshold at every timestep and for every neuron. In the event-based processing of the present disclosure, neuron potential is re-evaluated upon arrival of events, and in between processing events, the system may shutdown or reduce power significantly to the neurons.

The methods, systems, and apparatus discussed above are merely exemplary. Various configurations may omit, substitute, or add various procedures or components as appropriate. For instance, in alternative configurations, the methods may be performed in an order different from that described, and various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Embodiments of the present disclosure, for example, are described above with reference to block diagrams and/or operational illustrations of methods, systems, and computer program products according to embodiments of the present disclosure. The functions/acts noted in the blocks may occur in a different order than shown in any flowchart. For example, two blocks shown in succession may be executed substantially concurrently or the blocks may sometimes be executed in the reverse order, depending upon the functionality/acts involved. Additionally, or alternatively, not all of the blocks shown in any flowchart need to be performed and/or executed. For example, if a given flowchart has seven blocks containing functions/acts, it may be the case that only five of the seven blocks are performed and/or executed. In this example, any of five of the seven blocks may be performed and/or executed.

Specific details are given in the description to provide a thorough understanding of example configurations (including implementations). However, configurations may be practiced without these specific details. For example, well-known circuits, processes, algorithms, structures, and techniques have been shown without detail in order to avoid obscuring the configurations. This description provides example configurations only and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having been provided with the description and illustration of the present application, one skilled in the art may envision variations, modifications, and alternate embodiments falling within the general inventive concept discussed in this application that does not depart from the scope of the following claims.

We claim:

1. A system to process event-based data using a neural network, the neural network comprising a plurality of neurons associated with a corresponding portion of the event-based data received at the plurality of neurons, and one or more connections associated with each of the plurality of neurons, the system comprising:
a memory; and
a processor communicatively coupled to the memory, the processor being configured to:
receive, at a neuron of the plurality of neurons, a plurality of events associated with the event-based data over the one or more connections associated with the neuron, wherein each of the one or more connections is associated with a first kernel and a second kernel, and wherein each of the plurality of events belongs to one of a first category or a second category,
determine, at the neuron, a potential by processing the plurality of events received over the one or more connections, wherein to process the plurality of events, the processor is configured to:
when the received plurality of events belong to the first category, select the first kernel for determining the potential,
when the received plurality of events belong to the second category, select the second kernel for determining the potential, and
generate, at the neuron, output based on the determined potential.

2. The system of claim 1, wherein to determine the potential, the processor is further configured to:
receive an event of the plurality of events;
determine the corresponding connection of the one or more connection over which the event is received,
select one of the first kernel or the second kernel associated with the corresponding connection, based on whether the received event belongs to the first category or the second category,
offset the selected kernel in one of a spatial dimension, a temporal dimension, or a spatiotemporal dimension, and
determine the potential for the neuron based on processing of the offset kernel.

3. The system of claim 2, wherein the neural network comprises one of spatial kernel, temporal kernel, and spatiotemporal kernel, and
wherein to offset the selected kernel, the processor is further configured to:
when the network comprises spatial kernel, offset the selected kernel in one or more spatial dimensions,
when the network comprises temporal kernel, offset the selected kernel in the temporal dimension, and
when the network comprises spatiotemporal kernel, offset the selected kernel in a spatiotemporal dimension, wherein the spatiotemporal dimension includes the temporal dimension and the one or more spatial dimensions.

4. The system of claim 2, wherein to generate the potential, the processor is further configured to sum the offset kernel with an earlier potential, thereby determining the potential at the neuron.

5. The system of claim 1, wherein to determine the potential, the processor is further configured to:
receive an initial event at an initial time instance,
receive one or more subsequent events at subsequent time instances,
determine the corresponding connections of the one or more connections over which the initial event and the one or more subsequent events are received,
select, for each of the received initial event and the one or more subsequent events, one of the first kernel or the second kernel associated with the corresponding connections, based on whether the received initial event and the one or more subsequent events belong to the first category or the second category;
offset one or more of the selected kernels in one of the temporal dimension or the spatiotemporal dimension based on the initial time instance and the subsequent time instances, and
determine the potential for the neuron based on processing of the offset kernels.

6. The system of claim 5, wherein to offset the selected kernels in one of the temporal dimension or the spatiotemporal dimension, the processor is configured to:
determine time intervals between the initial time instance when the last event is received at the neuron and the preceding time instances when one or more preceding events are received at the neuron, the time intervals defining a difference in time of arrival of the events at the neuron,
offset the selected kernels corresponding to the one or more subsequent events based on the determined time intervals, and
sum the offset kernels in order to determine the potential at the neuron.

7. The system of claim 1, wherein each of the received events relates to:
increased presence or absence of one or more features of the event-based data when the corresponding events are associated with the first category, or
decreased presence or absence of one or more features of the event-based data when the corresponding events are associated with the second category.

8. The system of claim 1, wherein to generate the output, the processor is configured to:
compare the determined potential with one of a first threshold value and a second threshold value, wherein, when the determined potential is associated with a positive value, the processor is configured to compare the determined potential with a first threshold value, and when the determined potential is associated with a negative value, the processor is configured to compare the determined potential with a second threshold value, and
generate the output based on said comparison.

9. The system of claim 8, wherein the processor is configured to, prior to comparing the determined potential with one of the first threshold value and the second threshold value:
provide the determined potential to a nonlinear function, and
process the determined potential based on the nonlinear function to generate an intermediate value,
wherein to compare the determined potential with one of the first threshold value and the second threshold value, the processor is configured to:
determine whether the corresponding intermediate value is associated with a positive value or a negative value,
upon a determination that the corresponding intermediate value is associated with the positive value, compare the corresponding intermediate value with the first threshold value, and
upon a determination that the corresponding intermediate value is associated with the positive value, compare the corresponding intermediate value with the second threshold value.

10. The system of claim 1, wherein each of the first kernel and the second kernel is represented as a sum of orthogonal polynomials weighted by respective coefficients, wherein the respective coefficients are determined during training.

11. A system for processing event-based data using a neural network, the neural network comprising a plurality of neurons associated with a corresponding portion of the event-based data received at the plurality of neurons, and one or more connections associated with each of the plurality of neurons, the system comprising:
a memory; and
a processor communicatively coupled to the memory, the processor being configured to:
receive, at a neuron of the plurality of neurons, a plurality of events associated with the event-based data over the one or more connections associated with the neuron, wherein each of the one or more connections is associated with one or more kernel,
determine a potential of the neuron over the period of time based on processing of the kernels, wherein to determine the potential, the processor is configured to:
offset the kernels in one of a spatial dimension, a temporal dimension, or a spatiotemporal dimension, and
process the offset kernels in order to determine the potential, and
generate, at the neuron, output based on the determined potential.

12. The system of claim 11, wherein to process the offset kernels, the processor is configured to sum the offset kernels associated with the one or more connections over which the events are received, thereby determining the potential at the neuron.

13. The system of claim 11, wherein the neural network comprises one of spatial kernels, temporal kernels, and spatiotemporal kernels.

14. The system of claim 13, wherein:
when the network comprises spatial kernels, to determine the potential, the processor is configured to offset the spatial kernels corresponding to the received events in a spatial dimension,
when the network comprises temporal kernels, to determine the potential, the processor is configured to offset the temporal kernels corresponding to the received events in a temporal dimension, and
when the network comprises spatiotemporal kernels, to determine the potential, the processor is configured to offset the spatiotemporal kernels corresponding to the received events in a spatiotemporal dimension.

15. The system of claim 11, wherein for an event of the plurality of events:
to offset the kernels in the temporal dimension, the processor is configured to determine an offset value based on a time instance when the event is received at the neuron, and offset a corresponding kernel of the kernels in the temporal dimension based on the offset value,
to offset the kernels in the spatial dimension, the processor is configured to determine an offset value based on a position of an earlier neuron sending the event that is received at the neuron, and offset a corresponding kernel of the kernels in the spatial dimension based on the offset value, and
to offset the kernels in the spatiotemporal dimension, the processor is configured to determine an offset value based on a time instance when the event is received at the neuron and a position of an earlier neuron sending the event that is received at the neuron, and offset a corresponding kernel of the kernels in the spatial dimension based on the offset value.

16. The system of claim 14, wherein the processor is configured to:
receive, at the neuron, an initial event at an initial time instance,
receive, at the neuron, one or more subsequent events at subsequent time instances,
offset the kernels corresponding to the one or more subsequent events received at the subsequent time instances with respect to kernels corresponding to the initial event received at the initial time instance, and
sum the kernels corresponding to the one or more subsequent events received at the subsequent time instances, and the kernels corresponding to the initial event received at the initial time instance, thereby determining the potential at the neuron over the period of time.

17. The system of claim 16, wherein to offset the kernels, the processor is configured to:
determine time intervals between the initial time instance when the last event is received at the neuron and preceding time instances when one or more preceding events are received at the neuron, the time intervals defining a difference in time of arrival of the events at the neuron, and
offset the selected kernels corresponding to the one or more subsequent events based on the determined time intervals.

18. The system of claim 11, wherein each of the one or more connections is associated with a first kernel and a second kernel, and wherein each of the plurality of events belongs to one of a first category or a second category,
wherein when the received plurality of events belongs to the first category, the processor is further configured to select the first kernel for determining the potential, and
wherein when the received plurality of events belongs to the second category, the processor is further configured to select the second kernel for determining the potential.

19. The system of claim 18, wherein to determine the potential, the processor is further configured to:
receive an event of the plurality of events;
determine the corresponding connection of the one or more connection over which the event is received,
select one of the first kernel or the second kernel associated with the corresponding connection, based on whether the received event belongs to the first category or the second category,
offset the selected kernel in one of the spatial dimension, the temporal dimension, or the spatiotemporal dimension, and
determine the potential for the neuron based on processing of the offset kernel.

20. The system of claim 18, wherein each of the received events relates to:
increased presence or absence of one or more features of the event-based data when the corresponding events are associated with the first category, or
decreased presence or absence of one or more features of the event-based data when the corresponding events are associated with the second category.

21. The system of claim 11, wherein the determined potential is one of a positive value or a negative value, and wherein to generate the output, the processor is configured to:
compare the determined potential with one of a first threshold value and a second threshold value, wherein, when the determined potential is a positive value, the processor is configured to compare the determined potential with the first threshold value, and when the determined potential is a negative value, the processor is configured to compare the determined potential with a second threshold value, and
generate the output based on said comparison.

22. The system of claim 21, wherein the processor is configured to, prior to comparing the determined potential with one of the first threshold value and the second threshold value: provide the determined potential to a nonlinear function, and
process the determined potential based on the nonlinear function to generate an intermediate value,
wherein to compare the determined potential with one of the first threshold value and the second threshold value, the processor is configured to:
determine whether the corresponding intermediate value is associated with a positive value or a negative value,
upon a determination that the corresponding intermediate value is associated with the positive value, compare the corresponding intermediate value with the first threshold value, and
upon a determination that the corresponding intermediate value is associated with the positive value, compare the corresponding intermediate value with the second threshold value.

23. The system of claim 18, wherein each of the first kernel and the second kernel is represented as a sum of orthogonal polynomials weighted by respective coefficients, wherein the respective coefficients are determined during training.

24. A method for processing event-based data using a neural network, the neural network comprising a plurality of neurons and one or more connections associated with each of the plurality of neurons, each of the plurality of neurons being configured to receive a corresponding portion of the event-based data, the method comprising:
receiving, at a neuron of the plurality of neurons, a plurality of events associated with the event-based data over the one or more connections associated with the neuron, wherein each of the one or more connections is associated with a first kernel and a second kernel, and wherein each of the plurality of events belongs to one of a first category or a second category,
determining, at the neuron, a potential by processing the plurality of events received over the one or more connections, wherein processing the plurality of events comprises:
when the received plurality of events belong to the first category, selecting the first kernel for determining the potential,
when the received plurality of events belong to the second category, selecting the second kernel for determining the potential, and
generating, at the neuron, output based on the determined potential.

25. The method of claim 24, wherein determining the potential further comprises:
receiving an event of the plurality of events;
determining the corresponding connection of the one or more connection over which the event is received,
selecting one of the first kernel or the second kernel associated with the corresponding connection, based on whether the received event belongs to the first category or the second category,
offsetting the selected kernel in one of a spatial dimension, a temporal dimension, or a spatiotemporal dimension, and
determining the potential for the neuron based on processing of the offset kernel.

26. The method of claim 25, wherein the network comprises one of spatial kernel, temporal kernel, and spatiotemporal kernel, and
wherein offsetting the selected kernel comprises:
when the network comprises spatial kernel, offsetting the selected kernel in one or more spatial dimensions,
when the network comprises temporal kernel, offsetting the selected kernel in the temporal dimension, and
when the network comprises spatiotemporal kernel, offsetting the selected kernel in a spatiotemporal dimension, wherein the spatiotemporal dimension includes the temporal dimension and the one or more spatial dimensions.

27. The method of claim 25, wherein generating the potential comprises summing the offset kernel with an earlier potential, thereby determining the potential at the neuron.

28. The method of claim 24, wherein determining the potential further comprises:
receiving an initial event at an initial time instance,
receiving one or more subsequent events at subsequent time instances,
determining the corresponding connections of the one or more connections over which the initial event and the one or more subsequent events are received,
selecting, for each of the received initial event and the one or more subsequent events, one of the first kernel or the second kernel associated with the corresponding connections, based on whether the received initial event and the one or more subsequent events belong to the first category or the second category;
offsetting one or more of the selected kernels in one of the temporal dimension or the spatiotemporal dimension based on the initial time instance and the subsequent time instances, and
determining the potential for the neuron based on processing of the offset kernels.

29. The method of claim 28, wherein offsetting the selected kernels in one of the temporal dimension or the spatiotemporal dimension comprises:
determining time intervals between the initial time instance when a last event is received at the neuron and preceding time instances when one or more preceding events are received at the neuron, the time intervals defining a difference in time of arrival of the events at the neuron,
offsetting the selected kernels corresponding to the one or more subsequent events based on the determined time intervals, and
summing the offset kernels in order to determine the potential at the neuron.

30. The method of claim 24, wherein each of the received events relates to:
increased presence or absence of one or more features of the event-based data when the corresponding events are associated with the first category, or
decreased presence or absence of one or more features of the event-based data when the corresponding events are associated with the second category.

31. The method of claim 24, wherein generating the output comprises:
comparing the determined potential with one of a first threshold value and a second threshold value, wherein, when the determined potential is associated with a positive value, the method comprises comparing the determined potential with a first threshold value, and when the determined potential is associated with a negative value, the method comprises comparing the determined potential with a second threshold value, and
generating the output based on said comparison.

32. The method of claim 31, wherein the method comprises, prior to comparing the determined potential with one of the first threshold value and the second threshold value: providing the determined potential to a nonlinear function, and
processing the determined potential based on the nonlinear function to generate an intermediate value,
wherein comparing the determined potential with one of the first threshold value and the second threshold value comprises:
determining whether the corresponding intermediate value is associated with a positive value or a negative value,
upon determining that the corresponding intermediate value is associated with the positive value, comparing the corresponding intermediate value with the first threshold value, and
upon determining that the corresponding intermediate value is associated with the positive value, comparing the corresponding intermediate value with the second threshold value.

33. The method of claim 24, wherein each of the first kernel and the second kernel is represented as a sum of orthogonal polynomials weighted by respective coefficients, wherein the respective coefficients are determined during training.

34. A method for processing event-based input data using a neural network, the neural network comprising a plurality of neurons and one or more connections associated with each of the plurality of neurons, each of the plurality of neurons being configured to receive a corresponding portion of the event-based data, the method comprising:
receiving, at a neuron of the plurality of neurons, a plurality of events associated with the event-based data over the one or more connections associated with the neuron, wherein each of the one or more connections is associated with one or more kernels,
determining a potential of the neuron over the period of time based on processing of the kernels, wherein determining the potential comprises:
offsetting the kernels in one of a spatial dimension, a temporal dimension, or a spatiotemporal dimension, and
processing the offset kernels in order to determine the potential, and
generating, at the neuron, output based on the determined potential.

35. The method of claim 34, wherein processing the offset kernels comprises summing the offset kernels associated with the one or more connections over which the events are received, thereby determining the potential at the neuron.

36. The method of claim 34, wherein the neural network comprises one of spatial kernels, temporal kernels, and spatiotemporal kernels.

37. The method of claim 36, wherein:
when the network comprises spatial kernels, determining the potential comprises offsetting the spatial kernels corresponding to the received events in a spatial dimension,
when the network comprises spatial kernels, determining the potential comprises offsetting the temporal kernels corresponding to the received events in a temporal dimension, and
when the network comprises spatial kernels, determining the potential comprises offsetting the spatiotemporal kernels corresponding to the received events in a spatiotemporal dimension.

38. The method of claim 34, wherein for an event of the plurality of events:
offsetting the kernels in the temporal dimension comprises determining an offset value based on a time instance when the event is received at the neuron, and offsetting a corresponding kernel of the kernels in the temporal dimension based on the offset value,
offsetting the kernels in the spatial dimension comprises determining an offset value based on a position of an earlier neuron sending the event that is received at the neuron, and offsetting a corresponding kernel of the kernels in the spatial dimension based on the offset value, and
offsetting the kernels in the spatiotemporal dimension comprises determining an offset value based on a time instance when the event is received at the neuron and a position of an earlier neuron sending the event that is received at the neuron, and offsetting a corresponding kernel of the kernels in the spatial dimension based on the offset value.

39. The method of claim 37, further comprising:
receiving, at the neuron, an initial event at an initial time instance,
receiving, at the neuron, one or more subsequent events at subsequent time instances,
offsetting the kernels corresponding to the one or more subsequent events received at the subsequent time instances with respect to kernels corresponding to the initial event received at the initial time instance, and
summing the kernels corresponding to the one or more subsequent events received at the subsequent time instances, and the kernels corresponding to the initial event received at the initial time instance, thereby determining the potential at the neuron over the period of time.

40. The method of claim 39, wherein offsetting the kernels comprises:
determining time intervals between a last time instance when the initial event is received at the neuron and preceding time instances when one or more preceding events are received at the neuron, the time intervals defining a difference in time of arrival of the events at the neuron, and
offsetting the selected kernels corresponding to the one or more subsequent events based on the determined time intervals.

41. The method of claim 34, wherein each of the one or more connections is associated with a first kernel and a second kernel, and wherein each of the plurality of events belongs to one of a first category or a second category,
wherein when the received plurality of events belongs to the first category, the method further comprises selecting the first kernel for determining the potential, and
wherein when the received plurality of events belongs to the second category, the method further comprises selecting the second kernel for determining the potential.

42. The method of claim 41, wherein determining the potential further comprises:
receiving an event of the plurality of events;
determining the corresponding connection of the one or more connection over which the event is received,
selecting one of the first kernel or the second kernel associated with the corresponding connection, based on whether the received event belongs to the first category or the second category,
offsetting the selected kernel in one of the spatial dimension, the temporal dimension, or the spatiotemporal dimension, and
determining the potential for the neuron based on processing of the offset kernel.

43. The method of claim 41, wherein each of the received events relates to:
increased presence or absence of one or more features of the event-based data when the corresponding events are associated with the first category, or
decreased presence or absence of one or more features of the event-based data when the corresponding events are associated with the second category.

44. The method of claim 34, wherein the determined potential is one of a positive value or a negative value, and wherein generating the output comprises:
comparing the determined potential with one of a first threshold value and a second threshold value, wherein, when the determined potential is a positive value, the method comprises comparing the determined potential with the first threshold value, and when the determined potential is a negative value, the method comprises comparing the determined potential with a second threshold value, and
generating the output based on said comparison.

45. The method of claim 44, wherein the method comprises, prior to comparing the determined potential with one of the first threshold value and the second threshold value: providing the determined potential to a nonlinear function, and
processing the determined potential based on the nonlinear function to generate an intermediate value,
wherein comparing the determined potential with one of the first threshold value and the second threshold value comprises:
determining whether the corresponding intermediate value is associated with a positive value or a negative value,
upon determining that the corresponding intermediate value is associated with the positive value, comparing the corresponding intermediate value with the first threshold value, and
upon determining that the corresponding intermediate value is associated with the positive value, comparing the corresponding intermediate value with the second threshold value.

46. The method of claim 41, wherein each of the first kernel and the second kernel is represented as a sum of orthogonal polynomials weighted by respective coefficients, wherein the respective coefficients are determined during training.
